(19) United States
(12) Patent Application Publication
(10) Pub. No.: US 2025/0278137 A1
(43) Pub. Date: Sep. 4, 2025

(54) WHOLE-BODY HAPTIC SYSTEM, DEVICE, AND METHOD

(71) Applicant: Hatpx, Inc., San Luis Obispo, CA (US)

(72) Inventors: Jacob A. Rubin, Morro Bay, CA (US); Robert S. Crockett, San Luis Obispo, CA (US); Joseph R. Marino, San Luis Obispo, CA (US); Michael C. Eichermueller, Arroyo Grande, CA (US); Madeline K. Rubin, Morro Bay, CA (US)

(21) Appl. No.: 18/858,716

(22) PCT Filed: Apr. 21, 2023
(86) PCT No.: PCT/US2023/019494

§ 371 Date: Oct. 21, 2024

(51) Int. Cl. G06F 3/01; B25J 9/00; B25J 13/08; G09B 9/12

(52) U.S. Cl. CPC G06F 3/016; B25J 9/0006; B25J 13/085; G06F 3/014; G09B 9/12

(57) ABSTRACT

A haptic device and system including: a motion platform having an actuated degree of freedom configured to permit rotation about a longitudinal axis of a user's body; a lower-body exoskeleton, having: two actuated platforms, each platform configured to substantially support a user's weight during ambulation; an upper-body exoskeleton, having: two manipulators, each manipulator including at least three actuated degrees of freedom; and an interface garment, including: a first haptic glove coupled to the first manipulator of the upper-body exoskeleton, and a second haptic glove coupled to the second manipulator of the upper-body exoskeleton.

This application claims priority to U.S. Application No. 63/334,010, filed Apr. 22, 2022, entitled WHOLE-BODY HAPTIC DEVICE, incorporated herein in its entirety by reference.

This application claims priority to U.S. Application No. 63/395,747, filed Aug. 5, 2022, entitled HAPTIC SYSTEM, incorporated herein in its entirety by reference.

This application relates to U.S. application Ser. No. 14/981,414, now U.S. Pat. No. 9,652,037, U.S. application Ser. No. 15/372,362, now U.S. Pat. No. 9,904,358, U.S. application Ser. No. 15/591,019, now U.S. Pat. No. 10,222,859, U.S. application Ser. No. 16/245,145, now U.S. Pat. No. 10,732,711, and U.S. Application Ser. No. 16/807,029, now U.S. Pat. No. 11,061,472, all of which claim priority to U.S. Application No. 61/843,317. All of the aforementioned documents are incorporated in their entirety herein by reference.

### BACKGROUND

Various systems and processes are known in the art for providing haptic feedback. Haptic feedback systems interact with a user's sense of touch by applying mechanical forces, vibrations, or motions. Force feedback exoskeletons are a subcategory of haptic feedback systems that produce a net force on a body segment of a user.

### SUMMARY

In embodiments, a haptic device generally includes a motion platform including an actuated degree of freedom configured to permit rotation about a longitudinal axis of a user's body; a lower-body exoskeleton, including: two actuated platforms, each platform configured to substantially support a user's weight during ambulation; an upper-body exoskeleton, including: two manipulators, each manipulator including at least three actuated degrees of freedom; and an interface garment, including: a first haptic glove coupled to a first manipulator of the two manipulators, and a second haptic glove coupled to a second manipulator of the two manipulators.

In embodiments, the motion platform further includes a first actuated degree of freedom configured to permit rotation about a sagittal axis of the user's body, and a second actuated degree of freedom configured to permit rotation about a frontal axis of the user's body. In embodiments, the motion platform further includes the first actuated degree of freedom configured to permit translation along the sagittal axis of the user's body, a second actuated degree of freedom configured to permit translation along the frontal axis of the user's body, and
a third actuated degree of freedom configured to permit translation along the longitudinal axis of the user's body.

In embodiments, the motion platform further comprises a rotary electrical coupling configured to permit the actuated degree of freedom to continuously rotate at least about 720 degrees. In embodiments, the actuated degree of freedom of the motion platform is configured to rotate such that it substantially matches an orientation of a center of mass of a user. In embodiments, the sagittal and frontal degrees of freedom of the motion platform are actuated such that an orientation of a top surface of the motion platform substantially matches an orientation of a corresponding section of terrain of a computer-mediated environment.

In embodiments, the lower-body exoskeleton includes a first actuated degree of freedom configured to permit rotation about the longitudinal axis of the user's body, a second actuated degree of freedom configured to permit translation along a sagittal axis of the user's body, and
a third actuated degree of freedom configured to permit translation along a frontal axis of the user's body. In embodiments, lower-body exoskeleton comprises a belt-driven actuator. In embodiments, the lower-body exoskeleton comprises a holonomic drive system. In embodiments, the lower-body exoskeleton comprises a cable-driven actuator. In embodiments, the lower-body exoskeleton includes the first actuated degree of freedom configured to permit rotation about the longitudinal axis of the user's body, a second actuated degree of freedom configured to permit translation along the frontal axis of the user's body, a third actuated degree of freedom configured to permit translation along the sagittal axis of the user's body, a fourth actuated degree of freedom configured to permit rotation about the sagittal axis of the user's body, and a fifth actuated degree of freedom configured to permit rotation about the frontal axis of the user's body. In embodiments, degrees of freedom of the motion platform permitting rotation about the sagittal and frontal axes of the user's body are actuated to produce a planar approximation of non-planar terrain of a computer-mediated environment such that the fourth and fifth actuated degrees of freedom of the lower-body exoskeleton are actuated to substantially match a deviation of the non-planar terrain from the planar approximation.

In embodiments, the methods and systems include a multiple-degree-of-freedom motion capture system configured to track a position of a user's foot. In embodiments, the platforms of the lower-body exoskeleton are actuated so as to substantially match a position of a foot of a user projected onto a plane defined by a range of motion of the second and third actuated degrees of freedom.

In embodiments, the platforms of the lower-body exoskeleton further comprise a force sensor. In embodiments, the force sensor comprises at least three sensed degrees of freedom. In embodiments, the platforms of the lower-body exoskeleton are actuated to produce motion of the platforms proportional to a sensed force vector of the force sensor. In embodiments, the force sensor is configured to indicate the weight of a user. In embodiments, the force sensor is configured to sense a contact state of a user's foot with the platforms of the lower-body exoskeleton. In embodiments, a displacement of the platforms of the lower-body exoskeleton is modified by at least one property based on an interface between a representation of a user's foot in a computer-mediated environment and a virtual surface in the computer-mediated environment.

In embodiments, the first actuated degree of freedom of the lower-body exoskeleton is actuated so as to substantially match an orientation of a foot of a user. In embodiments, the actuated degrees of freedom of the lower-body exoskeleton are actuated so as to maintain a position and an orientation of a plant foot of a user relative to a user's center of mass during a change in direction of a user's motion during the ambulation.

In embodiments, the fourth and fifth actuated degrees of freedom of the lower-body exoskeleton comprise a parallel mechanism. In embodiments, the parallel mechanism comprises a rotary actuator coupled to a crank.

In embodiments, at least a portion of the lower-body exoskeleton is separated from a user by a membrane. In embodiments, at least a portion of the motion platform is also separated from the user by another membrane. In embodiments, the platforms of the lower-body exoskeleton comprise a first portion and a second portion which are physically separated from each other by the membrane. In embodiments, the first and second portions of the platforms of the lower-body exoskeleton are coupled to the membrane by use of a mechanical interface with a coefficient of friction of less than 0.05. In embodiments, the mechanical interface comprises a rolling element. In embodiments, the mechanical interface comprises an air bearing. In embodiments, the first and second portions of the platforms of the lower-body exoskeleton are coupled to each other by a magnetic coupling. In embodiments, the magnetic coupling further comprises a plurality of magnetic elements arranged with alternating polarity.

In embodiments, the membrane comprises an elastic element. In embodiments, the membrane comprises a first and second portion having substantially different elastic moduli. In embodiments, the membrane comprises an element with a sufficiently high yield strength and a sufficiently low magnetic susceptibility to avoid interfering with a magnetic coupling. In embodiments, at least a portion of the lower-body exoskeleton is recessed beneath a load-bearing surface capable of supporting the weight of the user. In embodiments, at least a portion of the motion platform is recessed beneath the load-bearing surface.

In embodiments, the manipulators of the upper-body exoskeleton each comprise at least 6 actuated degrees of freedom.

In embodiments, the methods, systems and devices further include a torso exoskeleton coupled to a torso of a user by use of an element capable of substantially supporting the user's weight. In embodiments, the element capable of substantially supporting the user's weight is also coupled to a leg of the user.

In embodiments, the methods systems and devices further include a torso exoskeleton having an actuated degree of freedom configured to permit translation along the longitudinal axis of the user's body. In embodiments, the actuated degree of freedom of the torso exoskeleton comprises a pneumatic actuator. In embodiments, the pneumatic actuator is coupled to a pressure regulator. In embodiments, the pressure regulator is configured to output a first pressure generating a force of the pneumatic actuator substantially equal and opposite to a sum of the weight of all components of the haptic device distal to the pneumatic actuator such that the distal components are substantially maintained in an energetic equilibrium relative to the force of gravity acting on them. In embodiments, the pressure regulator is configured to output a second pressure generating a force of the pneumatic actuator substantially equal and opposite to a sum of the weight of the distal components plus the weight of a user, such that both the distal components and the user's body are substantially maintained in an energetic equilibrium relative to the force of gravity acting on them. In embodiments, the pressure regulator is configured to further output a plurality of pressure states between zero and a second pressure state.

In embodiments, the upper-body exoskeleton includes a first actuated degree of freedom configured to permit rotation about a sagittal axis of the user's body, and a second actuated degree of freedom configured to permit rotation about a frontal axis of the user's body.

In embodiments, an orientation of another actuated degree of freedom of the upper-body exoskeleton is configured to substantially match the orientation of a user's upper body.

In embodiments, the platforms of the lower-body exoskeleton comprise a relatively soft cover providing sufficient flexibility when the platforms are in use by the user.

In embodiments, the platforms of the lower-body exoskeleton comprise a tapered edge.

In embodiments, the platforms of the lower-body exoskeleton comprise a rounded edge.

In embodiments, the platform of the lower-body exoskeleton is configured to emulate a foot control of a simulated vehicle. In embodiments, the platform of the lower-body exoskeleton is configured to emulate at least one of: a brake pedal or a gas pedal. In embodiments, the platform of the lower-body exoskeleton is configured to emulate an aircraft rudder pedal.

In embodiments, a haptic device includes a motion platform including: an actuated degree of freedom configured to permit rotation about the longitudinal axis of a user's body; a lower-body exoskeleton, comprising: two actuated platforms, each platform configured to substantially support a user's weight during ambulation; an upper-body exoskeleton, comprising: two manipulators, each manipulator including at least three actuated degrees of freedom; and an interface garment, including: a first haptic glove coupled to the first manipulator of the upper-body exoskeleton, and a second haptic glove coupled to the second manipulator of the upper-body exoskeleton.

### BRIEF DESCRIPTION OF THE DRAWINGS

FIG. 1 is a perspective view of a whole-body haptic device in accordance with an example embodiment in an exemplary pose illustrating operation of a simulated vehicle.

FIG. 2 is a perspective view of a whole-body haptic device in accordance with an example embodiment.

FIG. 3 is a perspective view of a motion platform in accordance with an example embodiment.

FIG. 4 is a perspective view of a lower-body exoskeleton in accordance with an example embodiment.

FIG. 5 is a perspective view of an actuated degree of freedom configured to permit translation along a frontal axis of a user's body and an actuated degree of freedom configured to permit translation along the sagittal axis of a user's body of the lower-body exoskeleton in accordance with the example embodiment of FIG. 4.

FIG. 6A is a perspective view of actuated degrees of freedom of the lower-body exoskeleton of the example embodiment of FIG. 4 configured to permit rotation about a longitudinal axis passing through the center of rotation of the user's foot, an actuated degree of freedom configured to permit rotation about a sagittal axis passing through the center of rotation of the user's foot, and an actuated degree of freedom configured to permit rotation about the frontal axis passing through the center of rotation of the user's foot in accordance with an example embodiment.

FIG. 6B is a perspective view of the underside of a top portion of a platform of the lower-body exoskeleton in accordance with the example embodiment of FIG. 6A.

FIG. 7A is a perspective view of an actuated degree of freedom of a torso exoskeleton configured to permit translation along the longitudinal axis of a user's body in accordance with an example embodiment.

FIG. 7B is a perspective cutaway view of the actuated degree of freedom of the torso exoskeleton in accordance with the example embodiment of FIG. 7A.

FIG. 8A is a perspective view of an upper-body exoskeleton in accordance with an example embodiment.

FIG. 8B is a rear perspective cutaway view of the upper-body exoskeleton in accordance with the example embodiment of FIG. 8A.

FIG. 9 is a perspective view of another whole-body haptic device in accordance with an example embodiment in an exemplary pose illustrating operation of a simulation.

FIG. 10 is a perspective view of another motion platform of the whole-body haptic device of FIG. 9 in accordance with an example embodiment.

FIG. 11 is a perspective view of a motion platform motor of the motion platform of FIG. 10 in accordance with an example embodiment.

FIG. 12 is a perspective view of a base assembly of the whole-body haptic device of FIG. 9 in accordance with an example embodiment.

FIG. 13 is a perspective view of a gantry and a footplate form in accordance with an example embodiment.

FIG. 14 is a perspective view of a foot platform actuator of FIG. 13 in accordance with an example embodiment.

FIG. 15 is a perspective view of actuated degrees of freedom of the lower-body exoskeleton in accordance with an example embodiment configured to permit rotation about a longitudinal axis passing through the center of rotation of the user's foot, actuated degrees of freedom configured to permit rotation about a sagittal axis passing through the center of rotation of the user's foot, actuated degrees of freedom configured to permit rotation about the frontal axis passing through the center of rotation of the user's foot, and actuated degrees of freedom configured to permit translation along a longitudinal axis of the user's foot in accordance with an example embodiment.

FIG. 16 is a perspective view of a core assembly of FIG. 9 in accordance with an example embodiment.

FIG. 17 is a perspective view of an interface portion of the core assembly of FIG. 16 in accordance with an example embodiment.

FIG. 18 is a perspective view of a torso portion of the core assembly of FIG. 16 in accordance with an example embodiment.

FIG. 19 is a perspective view of a pneumatic actuator of the core assembly of FIGS. 16 and 18 in accordance with an example embodiment.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

In some instances, well-known structures, materials, or operations are not shown or described in detail to avoid obscuring aspects of the example embodiments. A haptic feedback glove may include a soft glove made of a flexible material, thimbles over each finger and thumb, and tendons coupled to each finger thimble. One or more actuators may be connected to each tendon, so that the tendons may be used to apply pressure to the fingers. Tactors in the finger thimbles and on palm panels may also be used to provide haptic feedback.

### Technical Field

The disclosure relates generally to providing haptic feedback via a force feedback exoskeleton, and more specifically to providing whole-body haptic feedback via a force feedback exoskeleton.

### Definitions and Conventions

Unless otherwise indicated, terms throughout this document should be considered to have the same meanings assigned to them in U.S. Application Nos. 61/843,317 and 63/334,010 and the related documents incorporated by reference herein.

References to direction of motion should be generally understood to follow standard anatomical conventions relative to a standing user in a grounded reference frame. For instance, unless otherwise specified a rotation around the longitudinal axis (or vertical axis) refers to a rotation around the long axis of the body of a user standing in a neutral anatomical posture. This disclosure additionally contains references to axes relative to a foot of a user. For example, degrees of freedom may permit rotation about a longitudinal passing through the center of rotation of the user's foot, sagittal axis passing through the center of rotation of the user's foot, and frontal axis passing through the center of rotation of the user's foot.

### Overview

U.S. Application No. 61/843,317 discloses the first practical architecture for a whole-body human-computer interface, including a whole-body haptic device. 61/843,317 discloses the fundamental architecture of such a device, comprising: an exoskeleton including structural members coupled to one another by at least one articulation configured to apply a force to a body segment of a user, and an interface laminate configured to operatively couple the exoskeleton to a user's body, while further providing tactile or thermal stimulation to the user's skin. Examples of this architecture have been successfully commercialized as HaptX® Gloves, finding applications in a wide variety of fields, including industry, defense, medicine, and robotics.

There remains a need for improvements in haptic devices.

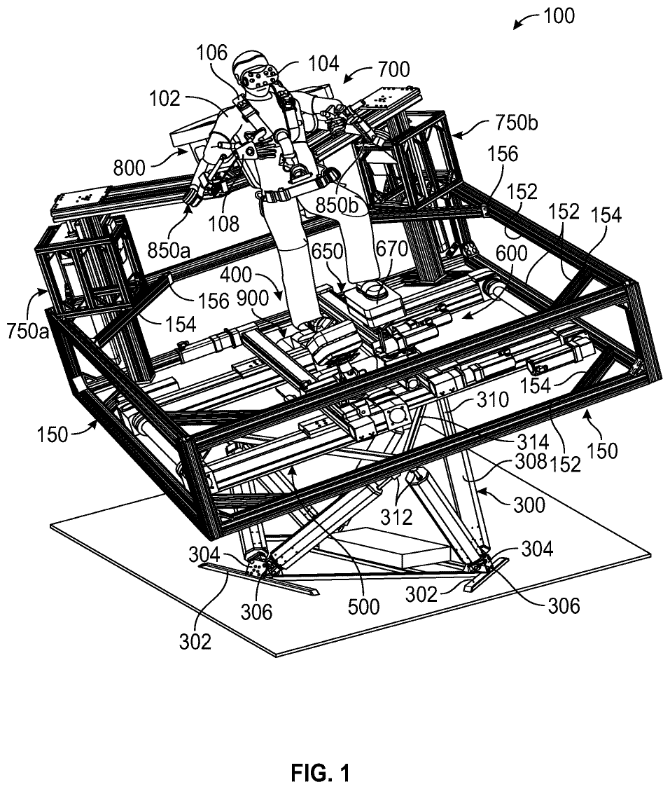

FIG. 1 shows a whole-body haptic device 100 (may also be referred to as a whole-body haptic system 100 or a full-body haptic system or device) in accordance with an example embodiment. To better illustrate the motion of the various degrees of freedom of the example embodiment of FIG. 1, the whole-body haptic device 100 may be configured in an exemplary pose demonstrating operation of a simulated vehicle by a user 102. In example embodiments, the whole-body haptic device or system 100 may be a holodeck type of system that may include a motion platform and a lower body exoskeleton that may provide various degrees of freedom. It will be appreciated in light of the disclosure that the whole-body haptic system 100 and various portions contained therein and combinations thereof contain ornamental features individually and in combination that are separate and apart from the many functional aspects disclosed herein.

The whole-body haptic device 100 may include a motion platform 300, interface garments 106, 108 (e.g., haptic glove 108), a lower-body exoskeleton 400, a torso exoskeleton 700, and an upper-body exoskeleton 800. User 102 wears a head-mounted display device 104 to provide audiovisual feedback.

Motion platform 300 is coupled to the lower-body exoskeleton 400 by a structural frame 150. In an example embodiment, the structural frame 150 may include extruded aluminum structural members 152 coupled by gussets 156 and reinforced by diagonal braces 154. In other example embodiments, the structural frame 150 may include any suitably rigid structural member, including metals such as aluminum, steel, and titanium, and polymers or polymer composites, such as glass or carbon fiber reinforced polymers.

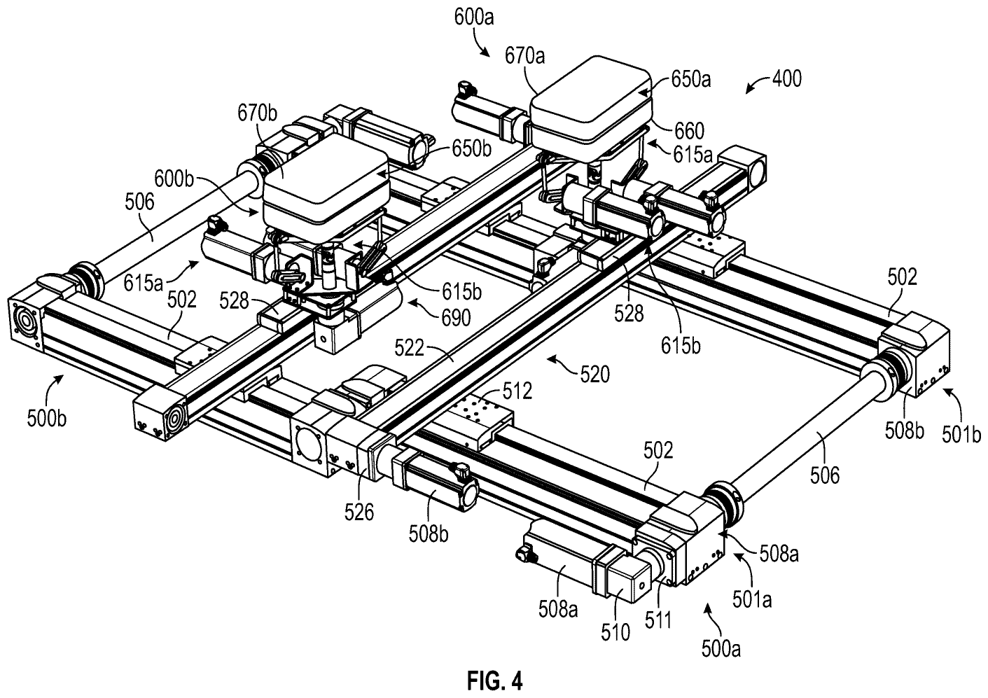

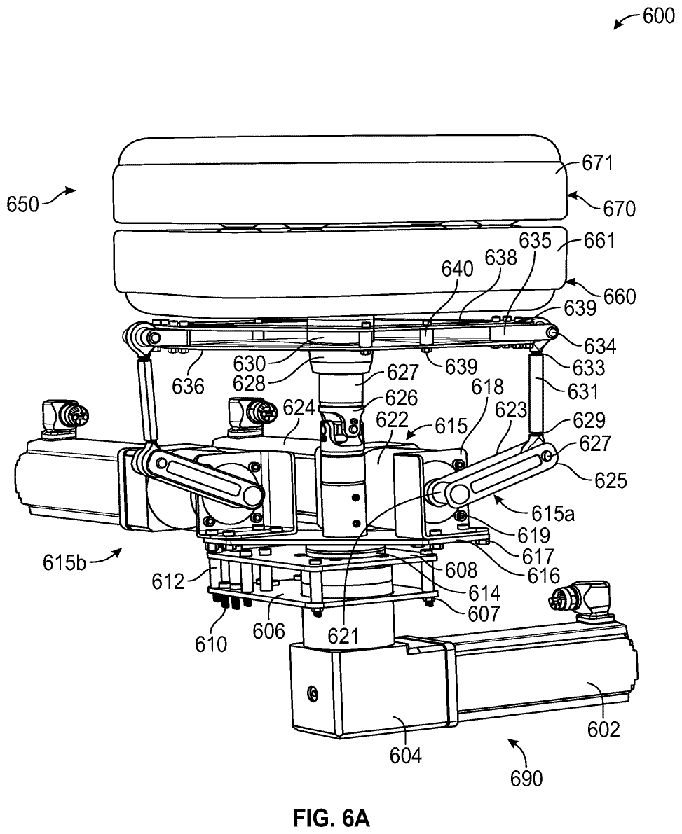

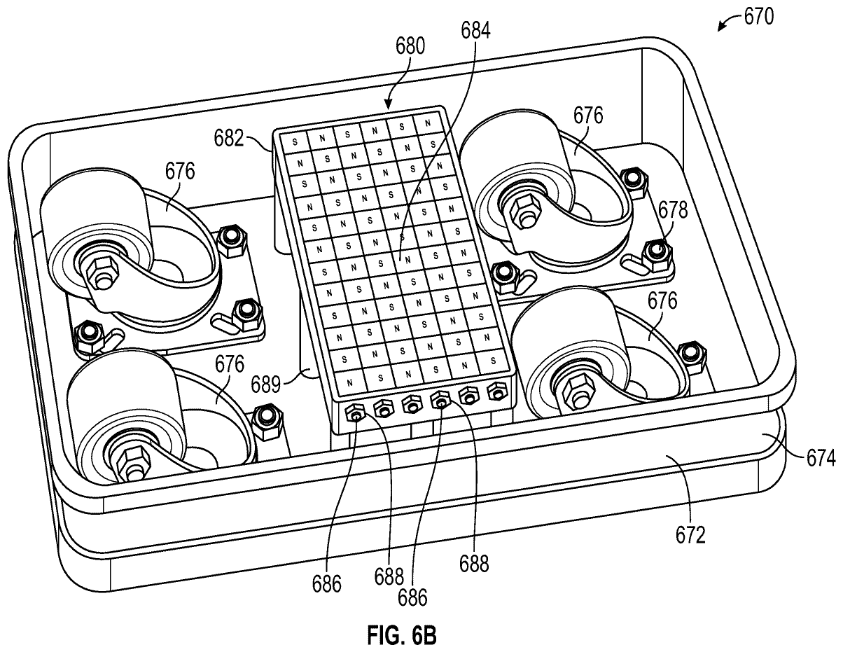

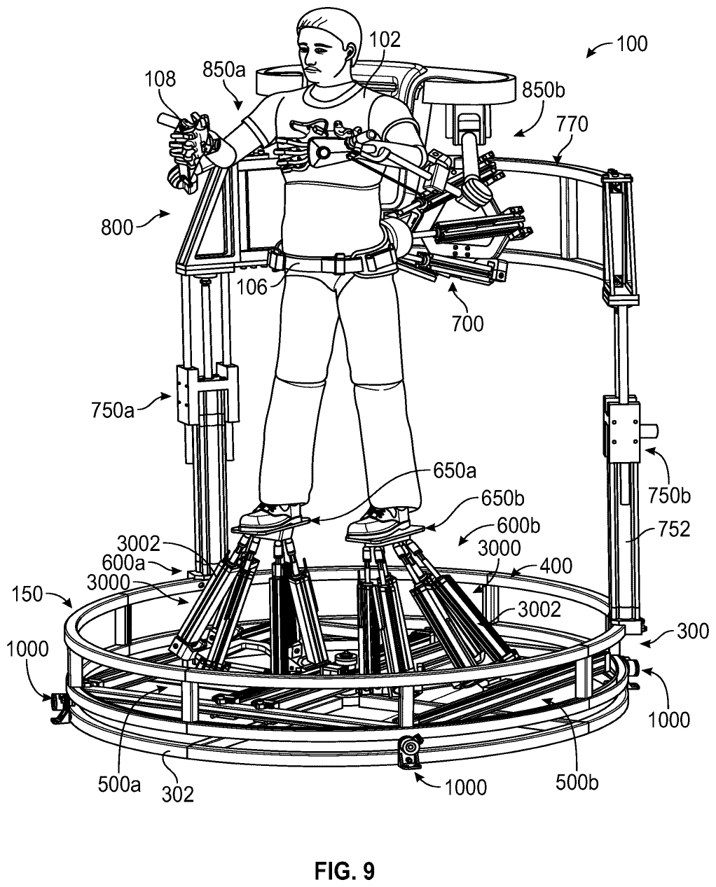

In example embodiments, the lower-body exoskeleton 400 may include a footplate 600 (as shown in FIGS. 4 and 6A). The footplate 600 may include the platform 650 as well as the actuated degrees of freedom between the gantry 500 and the platform 650. For example, the lower body exoskeleton 400 may include the gantry 500 and the footplate 600, where the footplate 600 may further include several actuated degrees of freedom that may collectively control the position of the platform 650. In some example embodiments, the platform 650 may have both a bottom portion 660 and an upper portion 670 that may be magnetically coupled through a membrane (as shown in FIGS. 4 and 6A and described in the disclosure). In other example embodiments (e.g., as shown in FIGS. 9-19), the platform 650 may be monolithic.

The structural frame 150 may be coupled to the torso exoskeleton 700, which is in turn coupled to the upper-body exoskeleton 800. The upper-body exoskeleton 800 may include a first manipulator 850a and second manipulator 850b, each of which may be coupled to the haptic glove 108 (e.g., as also referred to as one of the interface garments 108).

### Enclosure

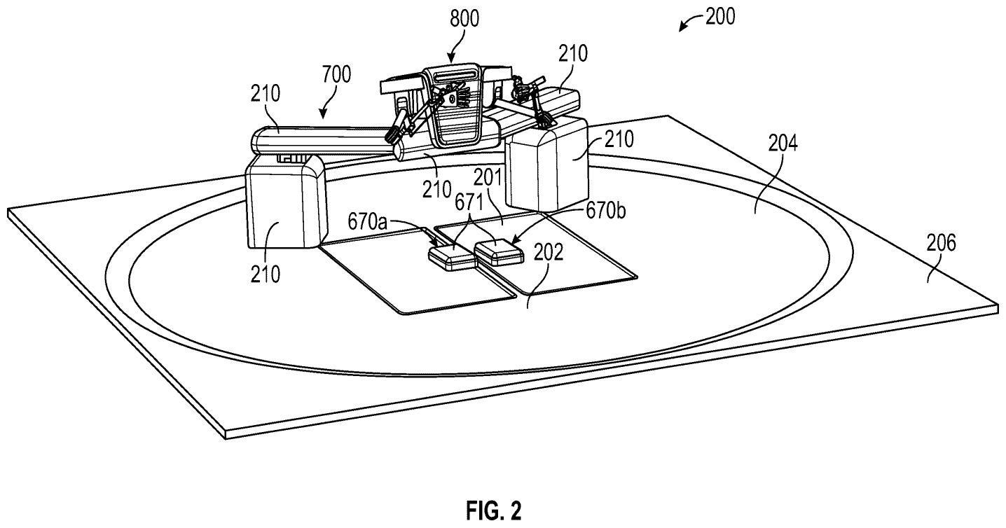

FIG. 2 shows a whole-body haptic device (e.g., the whole-body haptic device 100) with an enclosure 200 in accordance with an example embodiment. The enclosure 200 may enhance user safety by physically isolating a user from potentially dangerous mechanisms of the whole-body haptic device without impeding the operation of the haptic device. The enclosure 200 may also enhance aesthetic appeal of the whole-body haptic device.

In the example embodiment of FIG. 2, the whole-body haptic device may be configured to be partially recessed beneath a load-bearing surface 206 capable of supporting the weight of a human. In an example embodiment, the load-bearing surface 206 may include a modular access floor of the type commonly used in data centers, technical rooms, and offices of commercial buildings. Referring now to FIG. 1, the motion platform 300, the structural frame 150, and the lower-body exoskeleton 400 except for an upper portion 670 of a platform 650 (e.g., foot platform 650) may be recessed beneath the load-bearing surface 206 (e.g., as shown in FIG. 2).

Referring again to FIG. 2, the load-bearing surface 206 may be coupled to an outer membrane 204, which is in turn coupled to the structural frame 150. The outer edge of an inner membrane 202 is coupled to the structural frame 150 to form a continuous surface in combination with the outer membrane 204 and the load-bearing surface 206.

The membranes 202, 204 may include an elastomer, such as silicone rubber. The membranes 202, 204 may optionally include geometric features, such as corrugations, that may increase their displacement in the manner of a bellows. In another example embodiment, the membranes 202, 204 may include a substantially inelastic material, such as steel, aluminum, or fabric that may include a geometric feature of the type described in the disclosure permitting increased displacement.

The membranes 202, 204 may have a sufficiently high enough modulus of elasticity to allow a user to comfortably walk across their surface (e.g., when entering or exiting the whole-body haptic device), but a sufficiently low enough modulus of elasticity to permit displacement by the motion platform 300 and the lower-body exoskeleton 400 during operation.

In an example embodiment, the outer membrane 204 may have a relatively higher modulus of elasticity as compared to a modulus of elasticity of the inner membrane 202. The outer membrane 204 may be primarily displaced by operation of the motion platform 300, whereas the inner membrane 202 may be primarily displaced by operation of the lower-body exoskeleton 400. Given the substantially higher force output of a typical motion platform, an increased elastic modulus is appropriate for the outer membrane 204. This increased modulus may be achieved by use of sufficiently more rigid material or alternate geometry, such as by sufficiently increasing thickness.

The inner membrane 202 may include a first portion having a relatively increased elastic modulus and a second portion having a relatively reduced elastic modulus. In example embodiments, a membrane (e.g., the inner membrane 202) may include a first and second portion having substantially different elastic moduli. In the example embodiment of FIG. 2, inserts 201 may include a substantially inelastic but flexible material with a geometry approximating the workspace of each foot of a user. The inserts 201 may include a material with a sufficiently high yield strength and a sufficiently low magnetic susceptibility to avoid interfering with a magnetic coupling 680 (e.g., as shown in FIG. 6B) of the foot platform 650 (e.g., as shown in FIG. 6A) of the lower-body exoskeleton 400. Suitable materials for inserts 201 may include, but may not be limited to, thin sheets of substantially non-magnetic grades of stainless steel, such as 316 stainless steel, carbon, or glass fiber reinforced polymer sheets, and/or durable synthetic fabrics, such as nylon or polypropylene.

The upper portions 670 (e.g., upper portions 670a, 670b as shown in FIG. 2) of the foot platforms 650 (e.g., foot platforms 650a, 650b as shown in FIG. 4) of the lower-body exoskeleton 400 may each include a cover 671 (e.g., lower-body cover). The cover 671 may include a material, such as silicone rubber, that may be substantially elastic. Furthermore, the edges of the upper portions 670a, 670b may be rounded or tapered, as shown in FIG. 2, such that an object impacting the edges may tend to be deflected up and away from the surface of the inserts 201 and/or the membranes 202, 204. The combination of such a geometry with the substantially elastic material of the cover 671 may help to enhance user safety by reducing the maximum amount of energy that upper portions 670a, 670b may transfer to a body part of a user in case of accidental contact with the sides of the upper portions 670a, 670b during operation. In example embodiments, as shown in FIG. 2, there are various covers 210 (e.g., upper-body covers) for structural components of the upper-body exoskeleton 800. In example embodiments, the platforms (e.g., foot platforms 650) may include a relatively soft cover (e.g., providing sufficient flexibility when the platforms are in use by the user) as described in the disclosure. In example embodiments, the platforms 650 may include a tapered edge or a rounded edge (e.g., edges of the upper portions 670a, 670b) as described in the disclosure.

### Motion Platform

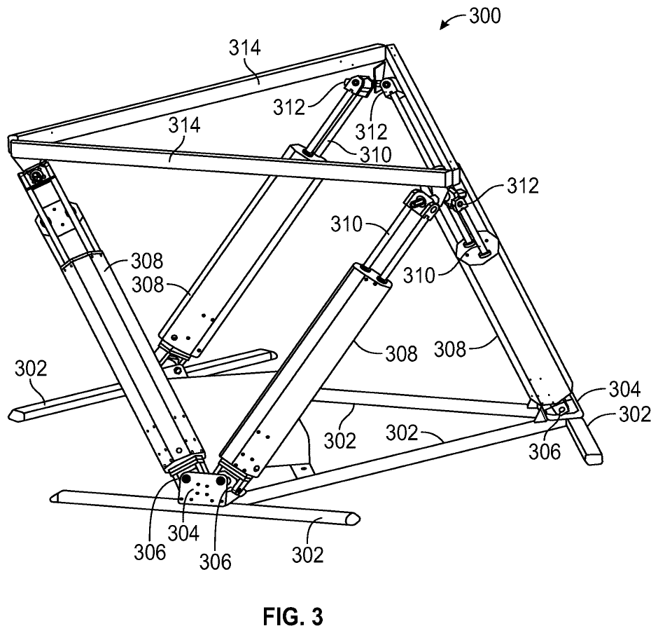

FIG. 3 shows the motion platform 300 of the whole-body haptic device 100 in accordance with an example embodiment. In the example embodiment of FIG. 3, the motion platform 300 may be of a “Stewart-type” geometry that is known to those skilled in the art. Stewart-type motion platforms may provide high acceleration, force output, and/or positioning accuracy due to their parallel kinematic architecture. Stewart-type motion platforms may also be readily available commercially, making them particularly suitable for the whole-body haptic device 100.

The motion platform 300 may include a base 302, coupled to brackets 304, each of which may be coupled to universal joints 306 (e.g., first universal joints 306). The first universal joints 306 may be coupled to ball-screw actuators 308, which may drive structural members 310. The structural members 310 may be coupled to universal joints 312 (e.g., second universal joints), which may in turn be coupled to a frame 314. The combined motion of ball-screw actuators 308 may control all six degrees of freedom of the frame 314 within the mechanism's workspace.

Various alternate actuation mechanisms may be contemplated for the motion platform 300, including but not limited to, lead screw and crank-based mechanisms. The motion platform 300 may be driven by any appropriate actuator familiar to those skilled in the art, such as electromechanical, pneumatic, and/or hydraulic actuators.

In example embodiments, the motion platform 300 may include at least an actuated degree of freedom configured to permit rotation about the longitudinal axis (or vertical axis) of a user's body. This degree of freedom may be provided to enable a user to change direction naturally during ambulation or other locomotion. As a user's center of mass rotates, this degree of freedom may be actuated such that components of a whole-body haptic device distal to the motion platform 300 may remain substantially aligned with the longitudinal orientation of the user's center of mass.

In example embodiments, an actuated degree of freedom of the motion platform 300 may be configured to permit rotation about the longitudinal axis of a user's body by including a rotary actuator at the distal end of the kinematic chain of the motion platform 300 configured to permit a rotation of at least about 720 degrees. In other example embodiments, the degree of freedom may be configured to permit continuous rotation. In some example embodiments, the motion platform 300 may include a rotary electrical coupling or connector, such as a slip ring, to enable power and data to pass through to other elements of a whole-body human-computer interface. For example, in some example embodiments, the motion platform 300 may include the rotary electrical coupling or connector that may be configured to permit the actuated degree of freedom to continuously rotate at least about 720 degrees. In example embodiments, the actuated degrees of freedom (e.g., fourth and fifth actuated degrees of freedom as described in the disclosure) of the lower-body exoskeleton 400 may include a parallel mechanism. The parallel mechanism may include a rotary actuator coupled to a crank. In example embodiments, as shown in FIG. 1, the rotary actuator may be a rotary actuator motor 900 that provides the rotation-related one or more degree(s) of freedom corresponding to the rotational movement of the motion platform 300.

In example embodiments, a whole-body haptic device having a motion platform with a single longitudinal degree of freedom, as described in the disclosure, may be sufficient to permit basic ambulation on a predominantly flat surface. However, additional degrees of freedom may be required to accurately simulate ambulation on slopes or uneven surfaces, as well as vehicle operation and other commercially important forms of non-ambulatory locomotion. Accordingly, in example embodiments, the motion platform 300 of a whole-body haptic device (e.g., whole-body haptic device 100) may include at least two additional actuated degrees of freedom, including: a first actuated degree of freedom configured to permit rotation about a sagittal axis of a user's body, and a second actuated degree of freedom configured to permit rotation about a frontal axis of a user's body.

In example embodiments, the sagittal and frontal degrees of freedom of the motion platform 300 may be actuated such that the orientation of a top surface of the motion platform 300 (e.g., the top surface of the frame 314 of the motion platform 300) may substantially match the orientation of a corresponding section of terrain of a computer-mediated environment during user ambulation. For example, the frame 314 may be tilted so as to present a simulated uphill slope that matches a virtual hill encountered in a computer-mediated environment. In example embodiments, the sagittal and frontal degrees of freedom of the motion platform 300 may be further actuated to emulate acceleration of a simulated vehicle via a three degree of freedom acceleration cueing algorithm of the type commonly known to those skilled in the art.

In an example embodiment, as shown in FIG. 3, a motion platform further includes: a first actuated degree of freedom configured to permit translation along the sagittal axis of a user's body, a second actuated degree of freedom configured to permit translation along the frontal axis of a user's body, and a third actuated degree of freedom configured to permit translation along the longitudinal axis of a user's body. The additional degrees of freedom, while not strictly necessary for simulating natural user locomotion in a computer-mediated environment, substantially improve the fidelity of the resulting simulation, particularly for motions that involve rapid accelerations. Six degrees of freedom motion cuing algorithms, as known to those skilled in the art, may be utilized to permit optimal use of both linear degrees of freedom (e.g., to simulate high frequency, short duration accelerations) and rotary degrees of freedom (e.g., to simulate low frequency, sustained accelerations).

### Exoskeleton

Referring now to FIG. 1, the whole-body haptic device 100 may include the lower-body exoskeleton 400, the torso exoskeleton 700, and the upper-body exoskeleton 800. The lower-body, torso, and upper-body exoskeletons form a continuous kinematic chain from the motion platform 300 to the interface garments 106, 108 and ultimately to the body of the user 102. Thus, the exoskeletons may enable the simulation of arbitrary grounded forces acting on the portions of the body of the user 102 to which they are coupled. In conjunction with cutaneous feedback that may be provided by interface garments 106, 108 (including tactile and/or thermal feedback), at least one exoskeleton of the whole-body haptic device (e.g., whole-body haptic device 100) may present a complete haptic representation of any simulated objects with which the user 102 may in interact a computer-mediated environment, closely approximating the full set of haptic sensations which may be present in an interaction with a comparable real-world object.

### Lower-body Exoskeleton

FIG. 4 shows the lower-body exoskeleton 400 in accordance with an example embodiment. The lower-body exoskeleton 400 may include a first gantry 500a and a second gantry 500b; one for each of a user's feet. In example embodiments, as described in the disclosure, the lower-body exoskeleton 400 may include the footplate 600 (e.g., 600a, 600b). Specifically, as shown in FIG. 4, there may be two separate footplates 600a, 600b for each foot (e.g., left foot and right foot). For example, the footplates 600a, 600b may be mirrored components that fit for the left and right feet respectively.

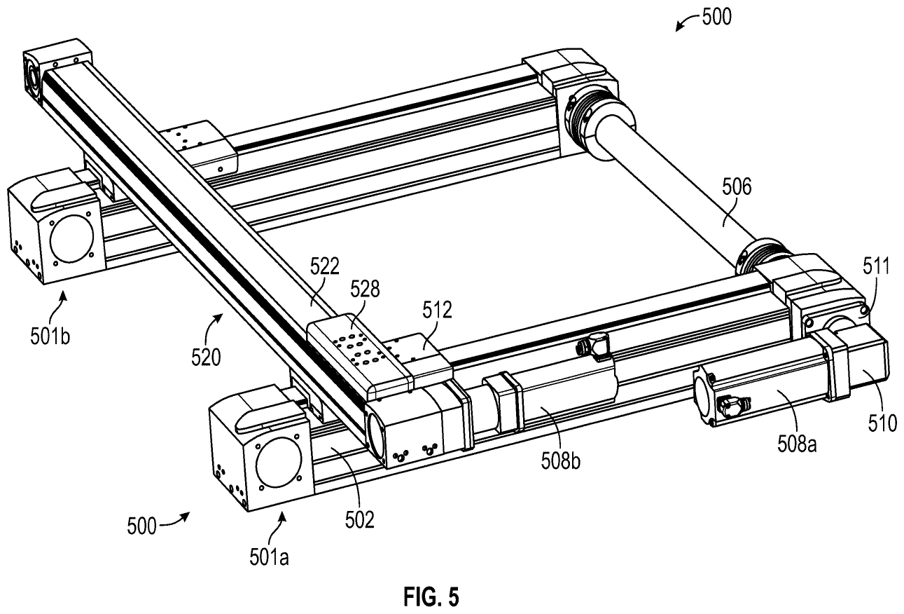

Referring now to FIG. 5, each gantry 500 (e.g., first gantry 500a or second gantry 500b) may include a first actuated degree of freedom 501 (e.g., degree of freedom 501a, 501b) configured to permit translation along the frontal axis of a user's body, and a second actuated degree of freedom 520 configured to permit translation along the sagittal axis of a user's body.

Actuated degrees of freedom 501 (e.g., degrees of freedom 501a, 501b), 520 of each gantry 500 (e.g., first gantry 500a or second gantry 500b) may include belt-driven actuators 502, 522. A servomotor 508 (e.g., servomotor 508a, 508b) may be coupled to a gear reducer 510, which may be in turn coupled to an input flange 511 of the belt-driven actuator 502. As the servomotor 508 (e.g., servomotor 508a, 508b) rotates, it may rotate the belt of the belt-driven actuator 502, which may in turn be coupled to a carriage 512 to produce controlled linear motion. This controlled linear motion may produce the degrees of freedom 501a, 501b. In example embodiments, the degrees of freedom 501a, 501b may include an actuated degree of freedom 501a that may be coupled to a second passive degree of freedom 501b. This may occur through the use of an identical belt-driven actuator 502 and by use of a coupling shaft 506 in example embodiments as described in the disclosure and shown in FIGS. 4-5 for each gantry 500 (e.g., gantry 500a, 500b). Pairing degrees of freedom 501a and 501b may provide a stable base for the lower-body exoskeleton 400 (e.g., as shown in FIG. 4), permitting the exoskeleton to accommodate larger loads.

Each gantry 500 (e.g., first gantry 500a or second gantry 500b) may further include an actuated degree of freedom 520 (e.g., the second actuated degree of freedom 520), including at least one belt-driven actuator 522, the servomotor 508 (e.g., the servomotor 508b), a gear reducer 526, and an output carriage 528. Each belt-driven actuator 522 may be coupled to the carriage 512 of the actuated degrees of freedom 501a, 501b to produce a two degree of freedom planar gantry. In example embodiments, each belt-driven actuator 522 may be coupled to the carriage 512 and/or the output carriage 528 to provide the actuated degree of freedom 520 (e.g., the second actuated degree of freedom 520) as shown in FIGS. 4-5 and described in the disclosure for each gantry 500 (e.g., gantry 500a, 500b). Referring again to FIG. 4, in example embodiments, a third actuated degree of freedom 690 may be configured to permit rotation about the longitudinal axis of a user's body that may be coupled to the output carriage 528 of each gantry 500. In example embodiments, as shown in FIGS. 4 and 6A, a servomotor 602 (e.g., similar to the servomotors 508a, 508b) may be coupled to a gear reducer 604, which may be in turn coupled to a crossed roller bearing 614 to form the third actuated degree of freedom 690.

In a first alternate example embodiment, the gantry 500 (e.g., first gantry 500a, second gantry 500b) may include a holonomic drive system of the type commonly found in omnidirectional wheeled robots, including at least three and more preferably four independently actuated omnidirectional wheels (such as omni-wheels or mecanum wheels). In one variation of this example embodiment, the wheels of the holonomic drive system may be directly driven by actuators on board the gantry. In a second variation example embodiment, the wheels of the holonomic drive system may be driven by a mechanical transmission, such as a flex shaft or hydrostatic transmission coupled to an externally located actuator to reduce moving mass.

In another example embodiment, the gantry 500 (e.g., first gantry 500a, second gantry 500b) may include a cable-driven mechanism, such as 10 planar parallel cable-driven mechanism including four actuated winches located approximately at the corners of a rectangle slightly larger than the desired workspace.

In example embodiments, the cable-driven mechanism may be a cable-driven actuator.

Three actuated degrees of freedom per foot, as described in the disclosure, may be sufficient to allow arbitrary in-plane motion of a user. In one example, a user may be walking in a straight line along a flat simulated surface in a computer-mediated environment. Each of the user's feet may be position tracked by a six degree of freedom motion capture system (or, more generally, a multiple-degree-of-freedom motion capture system having, e.g., two, three, four, five, or six degrees of freedom). In example embodiments, the motion capture system may include a passive optical tracking system, an active optical tracking system, or an electromagnetic motion capture system. During the swing phase of a user's ambulation, the platforms 650 (e.g., foot platforms 650a, 650b) may be actuated so as to substantially match the position of the user's foot projected onto the plane defined by the range of motion of the actuated degrees of freedom of the gantry 500 (e.g., first gantry 500a, second gantry 500b). Simultaneously, both the swing foot and stance foot platforms 650 may be actuated so as to substantially cancel out the user's net motion vector, as sensed by a position sensor located near a user's center of mass and/or a force sensor (e.g., a force sensor 630 such as a single or multi-axis force sensor 630) in the platforms 650, in a manner similar to the motion of a treadmill. In example embodiments, the force sensor (e.g., force sensor 630) may include at least three sensed degrees of freedom. In example embodiments, the platforms (e.g., foot platforms 650) may be actuated to produce motion proportional to a sensed force vector of the force sensor (e.g., force sensor 630). The force sensor (e.g., force sensor 630) may be configured to indicate (e.g., output a signal that varies with) a weight of a user. In example embodiments, the force sensor may be configured to sense a contact state (e.g., in contact with or not in contact with) of a user's foot with the platforms (e.g., foot platforms 650). Finally, in example embodiments, the motion platform 300 (e.g., as shown in FIG. 1) may be actuated so as to match the acceleration the user would have experienced had their net motion not been offset. The result may be a natural sense of ambulation, closely matching the forces and accelerations the user would experience during comparable real-world ambulation, without the need for a comparable space. Arbitrary slope of the simulated locomotion plane may be accommodated by actuation of the motion platform 300 (e.g., as shown in FIG. 1) up to the mechanical limits of the device, as described in the “Motion Platform” section of the disclosure.

In another example embodiment, a user may make a turn while walking along the same simulated surface. In this example, the platform 650 corresponding to the user's plant foot may need to stay fixed as the whole-body haptic device 100 (e.g., as shown in FIG. 1) and the rest of the user's body may rotate around it. Accordingly, the plant foot platform 650 may be rotated and translated so as to stay materially fixed in space relative to the user's reference frame. This may typically require simultaneous actuation of all three planar degrees of freedom of the lower-body exoskeleton 400 for the plant foot.

In another example embodiment, the displacement of platforms 650 may be modified by at least one property based on an interface or interaction between a representation of a user's foot in a computer-mediated environment and a virtual surface or simulated surface. The representation of the user's foot along with the virtual surface or simulated surface may be represented together in the same computer-mediated environment. For example, a user (e.g., user's feet) may interact with any simulated object or terrain (e.g., flat simulated surface or an uneven surface) in a computer-mediated environment, closely approximating the full set of haptic sensations (e.g., displacement of platforms 650) which may be present in this interaction with a comparable real-world object or terrain. In another example, there may be a specified number of actuated degrees of freedom (e.g., three degrees of freedom) applied to each foot to allow for ambulation on a predominantly flat surface. Additional degrees of freedom may be applied for accurate simulation of uneven surface having substantial changes of slope over short distances, such as stairs or rough terrain. In example embodiments, actuated degrees of freedom may be further actuated (e.g., causing modification of the displacement of platforms 650) to match the orientation of the surface (e.g., terrain) in the computer-mediated environment supporting the user's feet when walking over various types of terrain. For example, displacement may be amplified to represent slipping on a low friction surface, like ice, or conversely, displacement may be reduced to represent ambulation across a sticky surface, like tar.

In example embodiments, the lower-body exoskeleton 400 (e.g., as shown in FIG. 1) may have three actuated degrees of freedom per foot, as described in the disclosure, which may be sufficient to permit basic ambulation on a predominantly flat surface. However, additional degrees of freedom may be required for accurate simulation of uneven surfaces having substantial changes of slope over short distance, such as stairs or rough terrain. Accordingly, in example embodiments, the lower-body exoskeleton 400 (e.g., as shown in FIG. 1) may include at least two additional actuated degrees of freedom, including: a first actuated degree of freedom configured to permit rotation about the sagittal axis of a user's body, and a second actuated degree of freedom configured to permit rotation about the frontal axis of a user's body.

FIG. 6A shows actuated degrees of freedom configured to permit rotation about a vertical axis such as a longitudinal axis passing through the center of rotation of the user's foot, an actuated degree of freedom configured to permit rotation about a sagittal axis passing through the center of rotation of the user's foot, and an actuated degree of freedom configured to permit rotation about the frontal axis passing through the center of rotation of the user's foot of the lower-body exoskeleton of the example embodiment of FIG. 4. In example embodiments, a servomotor 602 (e.g., similar to servomotors 508a, 508b) may be coupled to a gear reducer 604, which may be in turn coupled to a crossed roller bearing 614 to form an actuated degree of freedom 690 (e.g., similar to the third actuated degree of freedom 690). The actuated degree of freedom 690 may be coupled to mounting plates 606, 608 which may be joined by fasteners 607 and spacers 612. Other fasteners 610 may join the mounting plate 606 to the output carriage 528 (e.g., as shown in FIG. 5). As shown, FIG. 6A also shows the footplate 600 as described in the disclosure.

In example embodiments, a structural plate 616 (e.g., base plate) may be coupled to the output flange of the crossed roller bearing 614 and to crank actuator assemblies 615a and 615b by use of fasteners 617. Each actuator assembly 615 (e.g., actuator assembly 615a, 615b) may include a mounting bracket 618 joined to a gear reducer 622 by fasteners 619. The gear reducer 622 may be coupled to another servomotor 624. An output shaft 621 of the gear reducer 622, driven by the servomotor 624, may be coupled to crank arms 623, 625, which may be in turn coupled to a shaft 627. The shaft 627 may be coupled to a first ball joint rod end 629, permitting two passive degrees of freedom. The first ball joint rod end 629 may be coupled to a rod 631, which may in turn be coupled to a second ball joint rod end 633. The second ball joint rod end 633 may terminate at a clevis 635 by way of a shaft 634.

Structural members 636 and 638, in combination with fasteners 639 and spacers 640 may form a substantially rigid structural frame, which may be coupled to clevises 635 on either end. In example embodiments, the clevises 635 may be mounted such that they are offset in both planar axes, as shown in FIG. 6A. In example embodiments, a universal joint 626 may be mounted approximately in the center of the assembly of FIG. 6A, coupling the structural plate 616 and the structural member 636. In example embodiments, a single or multi-axis force sensor 630 may optionally be mounted to the universal joint 626 by use of a mounting boss 628. The actuator assemblies 615a and 615b, in combination with the universal joint 626, may form a parallel two degree of freedom mechanism providing controlled motion about the sagittal and frontal axes of a user's body.

In an example embodiment, the degrees of freedom of the motion platform 300 (e.g., as shown in FIG. 1) permitting rotation about the sagittal and frontal axes of a user's body may be actuated to produce a planar approximation of terrain of a computer-mediated environment and the corresponding actuated degrees of freedom of the lower-body exoskeleton, as described in the disclosure, that may be actuated to substantially match a deviation of non-planar terrain from the planar approximation. In example embodiments, the non-planar terrain that may be generated within the computer-mediated environment may by a computer-generated three-dimensional representation of a real terrain or an artistically created terrain. For example, in simulating ascending a set of stairs in a computer-mediated environment, the motion platform 300 (e.g., as shown in FIG. 1) may be angled to match the slope of the staircase, and as the user's feet move over the staircase, the platforms 650 (e.g., foot platforms) of the lower-body exoskeleton 400 (e.g., as shown in FIG. 4) may be counter-rotated to closely approximate the stair treads. This additive approach to synthesis of uneven terrain may minimize the required range of motion of out-of-plane degrees of freedom of the lower-body exoskeleton 400 (e.g., as shown in FIG. 4), enabling a substantially less complex, less expensive, and safer device.

In another example embodiment, as shown in FIG. 1, degrees of freedom of the lower-body exoskeleton 400 permitting rotation about the sagittal and frontal axes of the foot of the user 102 may be employed to simulate foot controls of a simulated vehicle such as a ground, sea, or air vehicle. For example, the platforms 650 (e.g., foot platforms 650) of the lower-body exoskeleton 400 may be positioned to simulate the gas (e.g., gas pedal), brake (e.g., brake pedal), and/or clutch of a car or truck, or to simulate the rudder pedals of an airplane or aircraft (e.g., emulate an aircraft rudder pedal).

Referring once more to FIG. 6A, the actuated degrees of freedom 690 and the actuator assemblies 615a/b of the lower-body exoskeleton 400 (e.g., as shown in FIG. 1) may be coupled to each platform 650 (e.g., foot platform 650). In example embodiments, each platform 650 may include a bottom portion 660 and an upper portion 670 physically separated by insert(s) 201, and/or membrane(s) 202, 204 (e.g., as shown in FIG. 2) during operation and as described in the disclosure. The bottom portion 660 and the upper portion 670 each may include a mechanical interface to insert(s) 201, and/or membrane(s) 202, 204 (e.g., as shown in FIG. 2) that may permit in-plane motion with minimal friction. For example, first and second portions (e.g., the bottom portion 660 and the upper portion 670) of each platform 650 may be coupled to the insert(s) 201 and/or membrane(s) 202, 204 by use of the mechanical interface with a coefficient of friction of less than about 0.05. In example embodiments, the mechanical interface may include a rolling element, such as a caster 676 (e.g., as shown in FIG. 6B) or a ball bearing plate. In another example embodiment, the mechanical interface may include an air bearing. In example embodiments, as shown in FIG. 6A, the cover 671 may be an upper cover for the upper portion 670 and another cover 661 may be a bottom cover for the bottom portion 660, respectively. The bottom cover 661 may be the counterpart to the upper cover 671.

Referring now to FIG. 6B, in example embodiments, the bottom portion 660 and the upper portion 670 of the platform 650 may be coupled through insert(s) 201, and/or membrane(s) 202, 204 (e.g., as shown in FIG. 2) by use of the magnetic coupling 680. In example embodiments, the magnetic coupling 680 may include magnetic elements 684 that may be arranged in a checkerboard-like pattern of alternating polarity (as shown in FIG. 6B) to maximize the shear force required for decoupling relative to the strength of the magnetic elements 684. In example embodiments, the magnetic elements 684 may include through holes through which they may be coupled to a threaded rod 686, which may in turn be coupled to a steel pot 682 by a nut 688 in order to constrain and focus the magnetic field of the magnetic elements 684 in the direction of the coupling. The casters 676 and the magnetic coupling 680 may be coupled to chassis 672 by use of fasteners 678, 689 to form a complete functional unit. In example embodiments, the chassis 672 may include a cutout 674 to facilitate easy coupling to the cover 671 (e.g., as shown in FIG. 2) without the need for additional fasteners. The elasticity of the cover 671 (e.g., as shown in FIG. 2) may keep it in place once stretched over the chassis 672.

### Torso Exoskeleton

FIG. 1 shows the torso exoskeleton 700 in accordance with an example embodiment. The torso exoskeleton 700 may include another actuated degree of freedom 750 that may be configured to permit translation along the longitudinal axis of a user's body. As shown in FIG. 1, in example embodiments, the torso exoskeleton 700 may include the first and the second coupled degree of freedom 750a and 750b to increase force output and rigidity of the actuated degree of freedom 750.

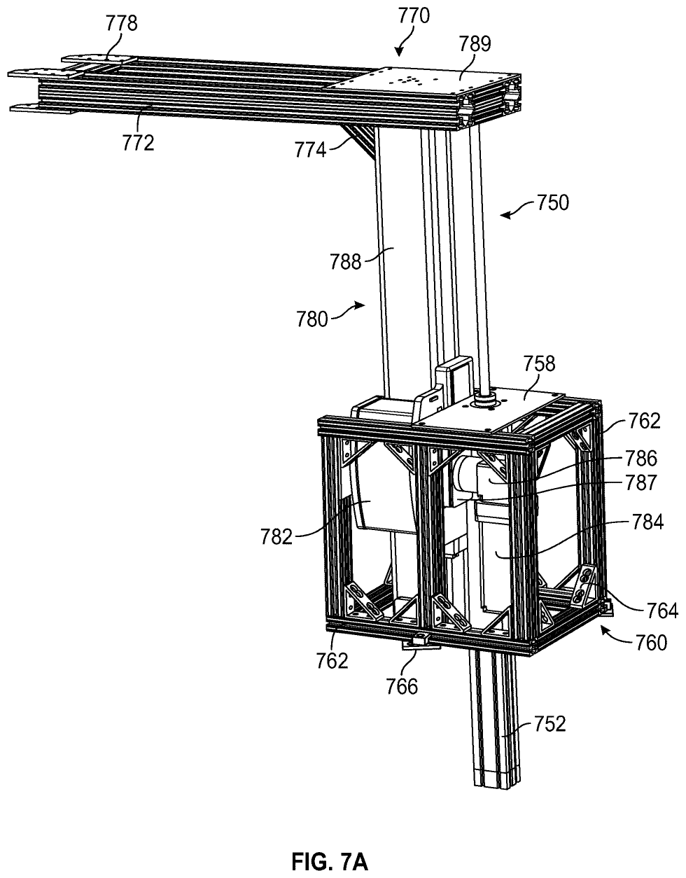

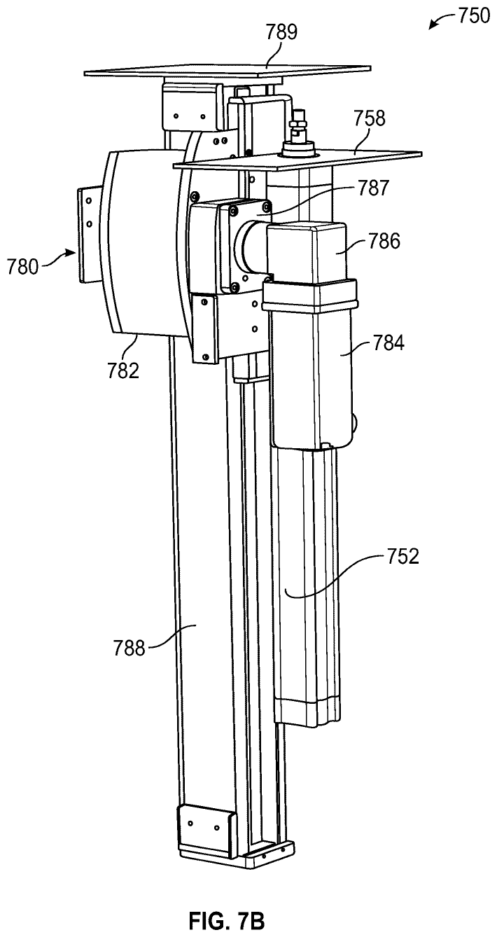

FIG. 7A shows a perspective view of the actuated degree of freedom 750 of the torso exoskeleton 700 configured to permit translation along the longitudinal axis of a user's body in accordance with an example embodiment. FIG. 7B is a perspective cutaway view of the actuated degree of freedom 750 of the torso exoskeleton 700 of the example embodiment of FIG. 7A omitting structural frames 760 and 770 (e.g., lower and upper structural frames 760, 770, respectively) for increased clarity.

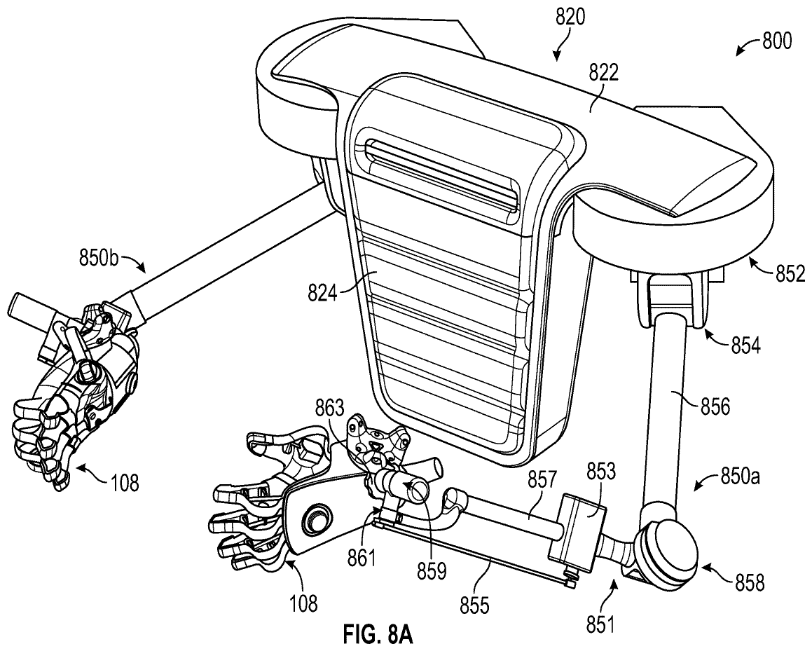

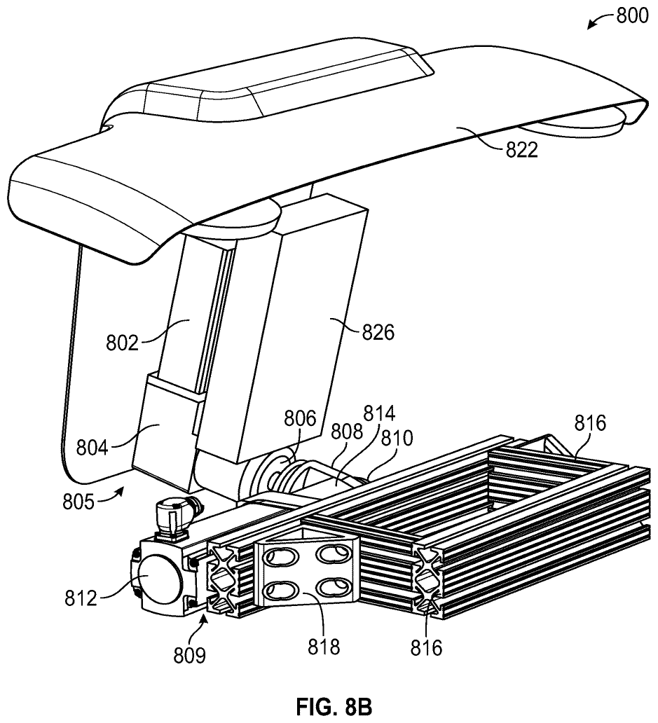

Referring now to FIGS. 7A and 7B, a servomotor 784 may be coupled to a gear reducer 786, which may in turn be coupled to an input flange 787 of a cantilever axis 780. A belt-drive unit 782 may translate rotation of the servomotor 784 into controlled linear displacement of a cantilever 788. At least one structural frame 760 may be a lower structural frame 760. The lower structural frame 760 may include structural extrusions 762, gussets 764, and mounting tabs 766. The lower structural frame 760 may couple the cantilever axis 780 to the structural frame 150 (e.g., as shown in FIG. 1). The other structural frame 770 may be an upper structural frame 770. The upper structural frame 770 may include structural extrusions 772 and a diagonal brace 774 that may be coupled to the cantilever 788 by use of a mounting plate 789. Mounting plates 778 may be configured to couple to the upper-body exoskeleton 800 (e.g., as shown in FIG. 8A). In example embodiments, as shown in FIGS. 1, 7A, and 7B, the servomotor 784 may be coupled to the gear reducer 786, which may in turn be coupled to the input flange 787 of the cantilever axis 780 as described in the disclosure. The belt-drive unit 782 may translate rotation of the servomotor 784 into controlled linear displacement of the cantilever 788 which may provide the actuated degree of freedom 750. In some example embodiments, a pneumatic actuator (e.g., pneumatic cylinder 752 as shown in FIGS. 7A-7B) may also or alternatively be utilized to provide the actuated degree of freedom 750.

In example embodiments, a pneumatic cylinder 752 (e.g., pneumatic actuator) may be coupled to the lower structural frame 760 by use of a mounting plate 758 and the upper structural frame 770 by use of the mounting plate 789, in parallel with the cantilever axis 780. The pneumatic cylinder 752 may be coupled to a pressure regulator, which may control its force output. In example embodiments, the pressure regulator may be configured to output a first pressure generating a force of the pneumatic cylinder 752 substantially equal and opposite to the sum of the weight of components (e.g., most if not all components) of a whole-body haptic device distal to the pneumatic cylinder 752 such that the distal components may be substantially maintained in an energetic equilibrium relative to the force of gravity acting on them. There may be a second pressure generating a force of the pneumatic cylinder 752 substantially equal and opposite to the sum of the weight of components (e.g., most if not all components) of a whole-body haptic device distal to the pneumatic cylinder 752 plus the weight of a user, such that both the distal components and the user's body may be substantially maintained in an energetic equilibrium relative to the force of gravity acting on them. In another example embodiment, the pressure regulator may be proportional, being configured to further output pressure states between about zero and a maximum rated pressure of the pneumatic cylinder 752.

In other example embodiments, the actuated degree of freedom 750 may include solely a fluidic actuator, such as a pneumatic or hydraulic cylinder or solely an electromechanical actuator such as a cantilever axis or other belt-driven actuator, a ball or lead screw actuator, or a crank-based actuator. However, a combination of both a fluidic and electromechanical actuator in parallel, as shown in the example embodiment of FIGS. 7A/B may present significant advantages. The pneumatic cylinder 752 may supply a constant gravity offset force calibrated to support the weight of distal elements of a whole-body haptic device and/or the weight of a user, as described in the disclosure, with minimal power consumption, while the cantilever axis 780 may provide higher precision force or position control than may be possible with a fluidic actuator alone. The pressure of the pneumatic cylinder 752 may additionally be calibrated to partially offset a user's body weight to permit greater ease of ambulation, particularly for disabled users, or even to simulate buoyancy (e.g., in a simulated underwater environment) or gravitational constants different from standard Earth surface gravity.

Referring now to FIG. 1, in an example embodiment, the torso exoskeleton 700 may include an actuated degree of freedom configured to permit translation along the sagittal axis of a user's body. The actuated degree of freedom may include a cantilever axis substantially similar to the cantilever axis 780 (e.g., as shown in FIG. 7A/B). This additional degree of freedom may be preferably employed to help keep the upper-body exoskeleton 800 and the user 102 substantially centered relative to the lower-body exoskeleton 400 during movement of the motion platform 300.

In addition to the gravity compensation functionality described in the disclosure, the torso exoskeleton 700 may be further employed to simulate sitting on a virtual surface in a computer-mediated environment. In this example embodiment, the torso exoskeleton 700 may be locked at a height corresponding to the height of a virtual sitting surface to constrain the user 102 to the virtual surface by use of the interface garment 106 and then unlocked as the user 102 stands up.

### Upper-body Exoskeleton

FIG. 8A shows the upper-body exoskeleton 800 in accordance with an example embodiment. The upper-body exoskeleton 800 may include the first manipulator 850a and the second manipulator 850b with substantially similar construction. In example embodiments, a manipulator 850 (e.g., the first manipulator 850a or the second manipulator 850b) may include at least three actuated degrees of freedom. In other example embodiments, as shown in the example embodiment of FIG. 8A, the manipulator 850 (e.g., the first manipulator 850a or the second manipulator 850b) may include six or more actuated degrees of freedom.

The base of the manipulator 850 may include a first actuated degree of freedom 852 and a second actuated degree of freedom 854 coupled to a structural member 856. For example, each manipulator 850a, 850b may provide the first actuated degree of freedom 852 and the second actuated degree of freedom 854. The structural member 856 may be further coupled to a third actuated degree of freedom 858 and a fourth actuated degree of freedom 851. For example, each manipulator 850a, 850b may provide the third actuated degree of freedom 858 and the fourth actuated degree of freedom 851 from the coupling to the structural member 856. A fifth actuated degree of freedom 861 may be remotely controlled by an actuator assembly 853, which may be coupled to the fifth actuated degree of freedom 861 by use of a drive rod 855 and a structural member 857. For example, the actuator assembly 853 may provide the fifth actuated degree of freedom 861 (e.g., via the drive rod 855 and the structural member 857). A sixth actuated degree of freedom 859 may be coupled to the haptic glove 108 by use of a mounting bracket 863. For example, the sixth actuated degree of freedom 859 may be provided due to the interaction of the haptic glove 108 with the mounting bracket 863. The manipulators 850a and 850b may produce grounded force feedback on a user's hands by use of haptic gloves 108. In example embodiments, the components in FIG. 8A may function together to provide the various actuated degrees of freedom 852, 854, 858, 851, 861, 859 as shown in FIG. 8A and described in the disclosure.

The manipulators 850a and 850b may be coupled to a back support assembly 820 that may include a structural frame 822 and a padded backrest 824. Referring now to FIG. 8B, in example embodiments, the structural frame 822 may be coupled to a fluidic drive system 826, which may control the haptic gloves 108. In example embodiments, the upper-body exoskeleton 800 may include at least two additional actuated degrees of freedom, including: a first actuated degree of freedom 805 configured to permit rotation about the sagittal axis of a user's body, and a second actuated degree of freedom 809 configured to permit rotation about the frontal axis of a user's body.

The actuated degree of freedom 805 (e.g., first actuated degree of freedom 805) may include or be provided by a servomotor 802 coupled to a gear reducer 804, which may in turn be coupled to a crossed roller bearing 806 that permits the rotation about the sagittal axis of the user's body. The actuated degree of freedom 809 (e.g., the second actuated degree of freedom 809) may include or be provided by a servomotor 812 coupled to a gear reducer 814, which may in turn be coupled to a crossed roller bearing 808 and a structural member 810 having a geometry that may permit the rotation about the frontal axis of a user's body. In example embodiments, this second actuated degree of freedom 809 may permit the rotation of distal elements of the upper-body exoskeleton 800 about the axis of rotation of the second actuated degree of freedom 809 without mechanical interference. In example embodiments, the structural frame 822 may include structural extrusions 816 and gussets 818 that may support the upper-body exoskeleton 800 and may couple it to the torso exoskeleton 700 (e.g., as shown in FIG. 1).

In example embodiments, the actuated degrees of freedom 805, 809 (e.g., the first actuated degree of freedom 805 and/or the second actuated degree of freedom 809) may be actuated to substantially match the orientation of the user's upper torso, as reported by a position sensor (e.g., a passive optical type of sensor, an active optical type of sensor, and/or an electromagnetic type of sensor), during operation of a whole-body haptic device. This may minimize the required workspace of manipulators 850a and 850b. In example embodiments, the actuated degrees of freedom 805, 809 may be further actuated to match the orientation of a surface in a computer-mediated environment supporting a user's back, while the user may be sitting. For example, the actuated degrees of freedom 805, 809 may be configured to match the angle of the seatback of a simulated reclining chair. In example embodiments, the orientation of another actuated degree of freedom of the upper-body exoskeleton 800 may be configured to substantially match an orientation of a user's upper body (e.g., user's upper torso).

### Interface Garment

FIG. 1 shows the interface garment 106, 108 of the whole-body haptic device 100, in accordance with an example embodiment. In example embodiments, the interface garment may include at least a pair of haptic gloves 108, such as HaptX® Gloves. In an example embodiment, the interface garment 106 may include a harness-like element coupled to the torso of the user 102, capable of substantially supporting the weight of the user 102. In another example embodiment, the interface garment 106 may also include a load-bearing element coupled to the legs of the user 102 to permit comfortable support of the body weight of the user 102 in a sitting position. The interface garment 106 may help ensure the safety of the user 102, supporting the user 102 against accidental falls in the typical manner of a harness.

In an example embodiment, the interface garment 106 may further include an interface laminate configured to stimulate the torso of the user 102 with tactile or thermal feedback. The interface laminate may also be extended to the user's extremities, particularly the upper arms and upper legs.

### Example Haptic Implementations With Actuator Assemblies

In example embodiments, FIGS. 9-19 show similar but slightly different implementations of the whole-body haptic device or system and its related components. The implementations of FIGS. 9-19 may utilize the same or similar components in order to provide the same or similar degrees of freedom to each of the user's feet, to each of the user's hands, and to the user's torso as shown in FIGS. 1-8B and described in the disclosure. In general, the same or similar degrees of freedom to each of the user's feet, to each of the user's hands, and to the user's torso are being provided between the example embodiments in FIGS. 1-8B and the example embodiments of FIGS. 9-19 with main differences relating to the approaches being used in terms of design configurations to provide the same or similar degrees of freedom to each of the user's feet, to each of the user's hands, and to the user's torso.

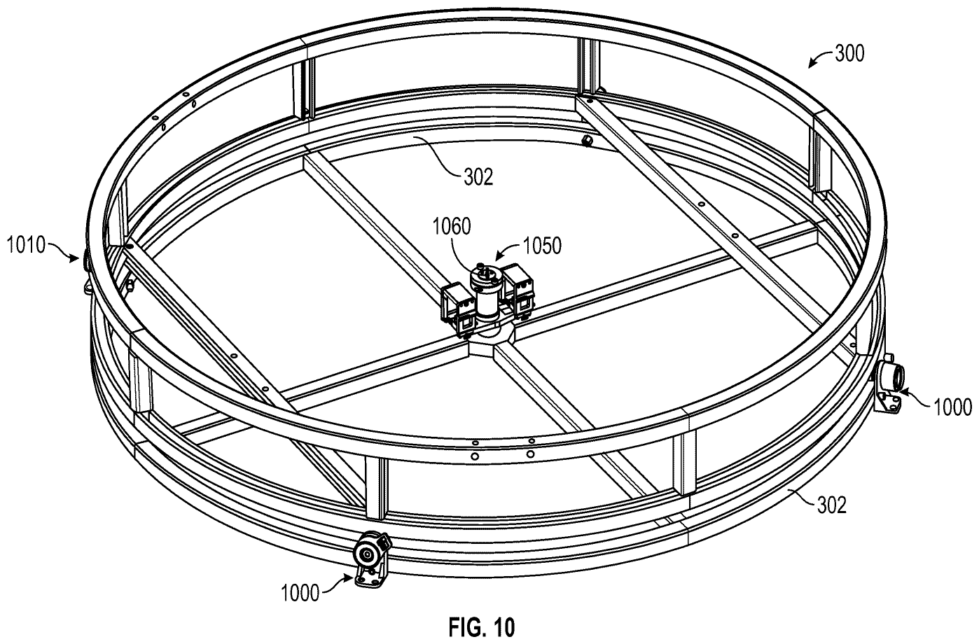

FIG. 9 shows another whole-body haptic device 100 (may also be referred to as a whole-body haptic system 100) in accordance with an example embodiment that is similar to the whole-body haptic device 100 of FIG. 1. In example embodiments, the whole-body haptic device or system 100 may be a holodeck type of system that includes a motion platform and a lower body exoskeleton that may provide various degrees of freedom. FIG. 9 shows the same or similar components in FIG. 1 that may provide the same functionality as described in the disclosure which may be implemented the same, in a similar manner, or slightly different from the implementations in FIG. 1. For example, the user 102 is shown using the whole-body haptic device 100 which includes interface garments 106, 108 (e.g., haptic glove 108), a structural frame 150, a motion platform 300 having a base 302, a lower-body exoskeleton, and gantries 500 (including first gantry 500a and second gantry 500b). The whole-body haptic device 100 may also include footplates 600a, 600b and foot platforms 650a, 650b for each foot, respectively. The whole-body haptic device 100 may also include a torso exoskeleton 700 and an upper-body exoskeleton 800 that may include a first manipulator 850a and a second manipulator 850b. The whole-body haptic device 100 may also include pneumatic cylinder(s) 752 and an upper structural frame 770. In example embodiments, the whole-body haptic device 100 may include actuated degrees of freedom 750 including a first coupled degree of freedom 750a and a second coupled degree of freedom 750b. As shown in FIG. 9, the whole-body haptic device 100 may include motion platform motors 1000 that may be attached to the base 302. In example embodiments, there may be only one motion platform motor 1000 with the other motion platform motors 1000 (e.g., as shown in FIGS. 9 and 10) being replaced with wheels. In another example embodiment, there may be only one motion platform motor 1000 positioned towards the center of the motion platform 300. In example embodiments, the whole-body haptic device 100 may include a foot platform actuator assembly 3000 that has foot platform actuator(s) 3002. There may be a foot platform actuator assembly 3000 for each foot as shown in FIG. 9. In example embodiments, the foot platform actuator assembly 3000 may be a Stewart platform type of actuator assembly (e.g., six foot platform actuators 3002). These components may be configured as shown in FIG. 9 and may provide the same or similar functionality as described in the disclosure. Together these components provide degrees of freedom to each of the user's feet, to each of the user's hands, and to the user's torso as shown in FIG. 9 similar to the degrees of freedom to each of the user's feet, to each of the user's hands, and to the user's torso in FIG. 1 as described in the disclosure. It will be appreciated in light of the disclosure that the whole-body haptic system 100 of FIGS. 1 and 9 and various portions contained therein and combinations thereof contain ornamental features individually and in combination that are separate and apart from the many functional aspects disclosed herein.

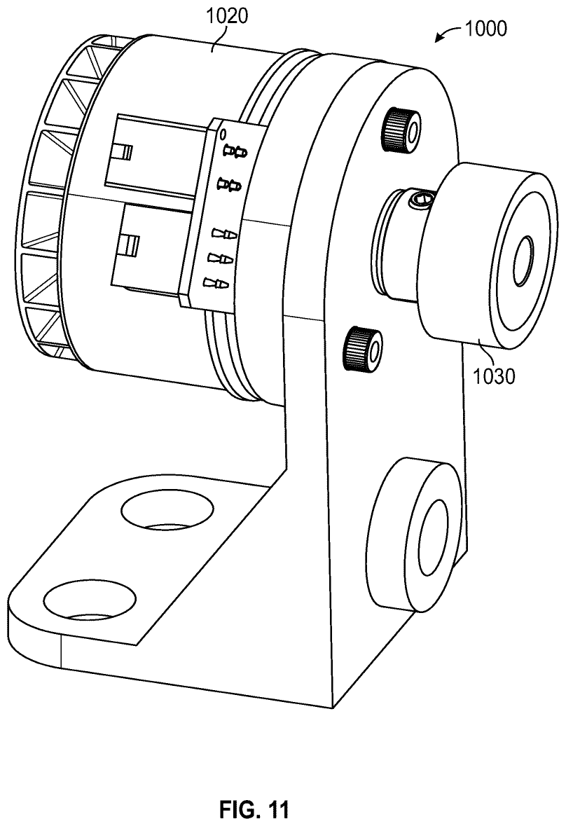

FIG. 10 shows the motion platform 300 of the whole-body haptic device 100 of FIG. 9 in accordance with an example embodiment. The motion platform 300 may be configured to rotate similarly to the rotation of the motion platform 300 in FIG. 1 but with a slightly different approach with the motion platform 300 in FIG. 10 being circular in shape providing some ease in providing the rotation. As shown, the motion platform 300 may include the base 302. In example embodiments, FIG. 3 also shows motion platform motors 1000 that may be attached to the base 302 of the motion platform 300. These motion platform motors may be used in providing movement (e.g., rotational movement around a user's longitudinal axis) for the motion platform 300. In example embodiments, a closer detailed view of the motion platform motor is shown in FIG. 11.

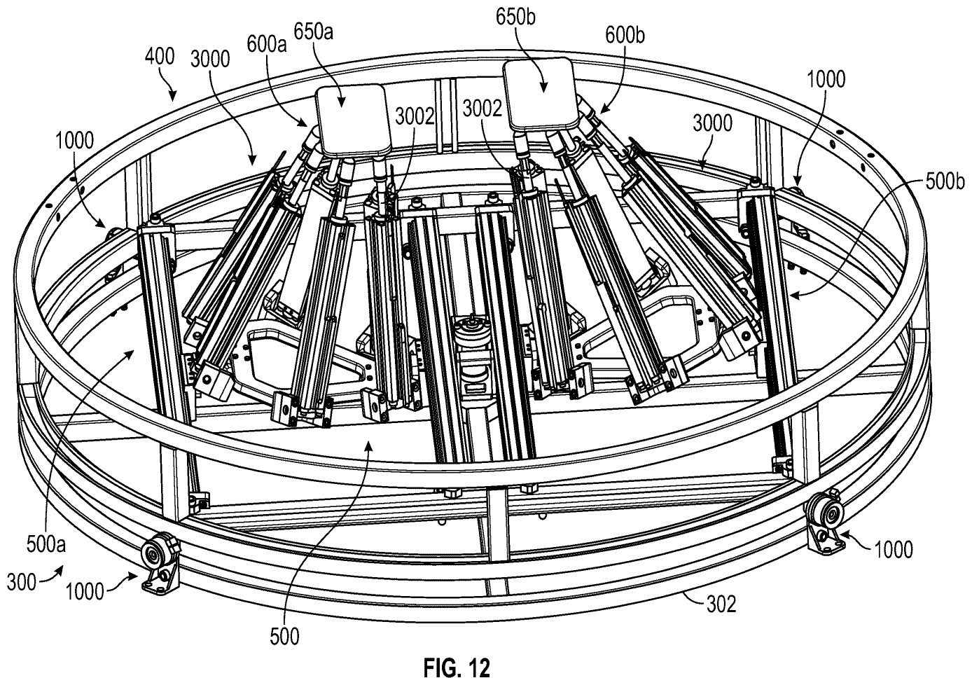

FIG. 12 shows a base assembly of the whole-body haptic device 100 of FIG. 9 in accordance with an example embodiment. In this example, the base assembly may include the lower-body exoskeleton 400 and the motion platform 300 that has the base 302. As described in the disclosure, there may also be motion platform motors that may be attached to the base 302 of the base assembly. The base assembly may also include gantries 500a, 500b as well as a foot platform actuator assembly 3000 (having foot platform actuator(s) 3002) for providing movement for the user's feet and specifically degrees of freedom as shown in FIGS. 9-19 and described in the disclosure and similar degrees of freedom at each of the user's feet as shown and described for the example embodiment of FIG. 1. The base assembly may also include footplates 600a, 600b and foot platforms 650a, 650b (e.g., first and second foot platforms) for each foot, respectively as described in the disclosure.

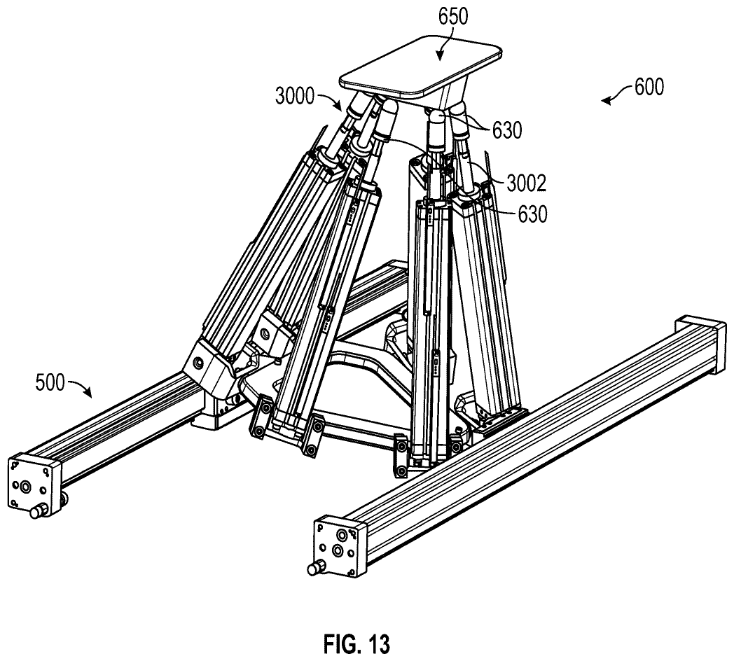

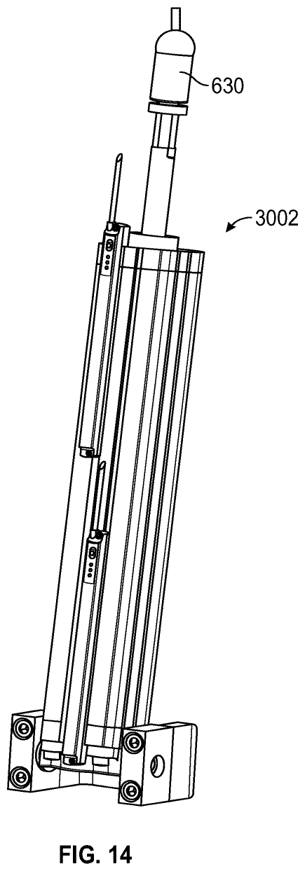

FIG. 13 shows at least one gantry 500 and the footplate 600 in accordance with an example embodiment. Each footplate 600 may include the foot platform actuator assembly 3000 (having the foot platform actuator(s) 3002) for providing movement of the foot platform 650 in terms of degrees of freedom as described in the disclosure. In example embodiments, as shown in FIG. 14, the foot platform actuator assembly 3000 may utilize the Stewart type of actuator assembly. Each of the platform actuators may include the force sensor 630 (e.g., single or multi-axis) to assist with providing the degrees of freedom as described in the disclosure. FIG. 14 shows the foot platform actuator 3002 of the foot platform actuator assembly 3000 in accordance with an example embodiment.

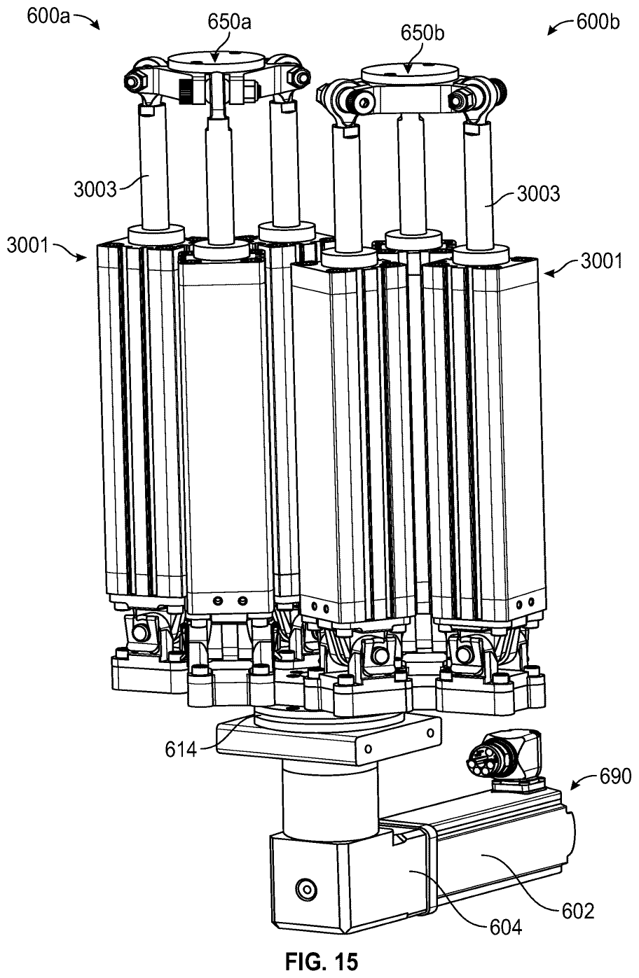

FIG. 15 shows a hybrid example embodiment in relation to the example embodiment of FIG. 1 specifically the example embodiment of FIG. 6A (e.g., showing a footplate 600). This hybrid example embodiment at least partially combines the example embodiment of FIG. 6A with the example embodiment of FIGS. 12 and 14 in terms of using similar actuator assemblies 3001 as part of the footplates 600a, 600b and under the foot platforms 650a, 650b. In this example embodiment, there may be several actuated degree(s) of freedom 690 provided such as an actuated degree of freedom configured to permit rotation about the vertical axis such as the longitudinal axis of a user's foot, an actuated degree of freedom configured to permit rotation about a sagittal axis of the user's foot, an actuated degree of freedom configured to permit rotation about the frontal axis of the user's foot, and an actuated degree of freedom configured permit translation along an axis extending longitudinally through the user's foot of the lower-body exoskeleton 400 of the example embodiment of FIG. 12. As shown in FIG. 15, this example embodiment may also include a servomotor 602, a gear reducer 604, and a crossed roller bearing 614 which may assist in providing the various actuated degrees of freedom as similarly described in the disclosure for FIG. 6A. For example, the crossed roller bearing provides for rotation of the foot platforms 650a, 650b. As described in the disclosure, there may also be the foot platform actuator assembly 3001 with foot platform actuator(s) 3003 to provide degrees of freedom in relation to the foot platforms 650. There may be only two foot platform actuator assemblies 3001 for each foot. The foot platform actuator assembly 3001 may be similar to the other foot platform actuator assembly 3000, however, each foot platform actuator assembly 3001 includes three foot platform actuators (instead of six foot platform actuators) providing three degrees of freedom for each actuator assembly and allowing various locations of a user's foot to be positioned independently.

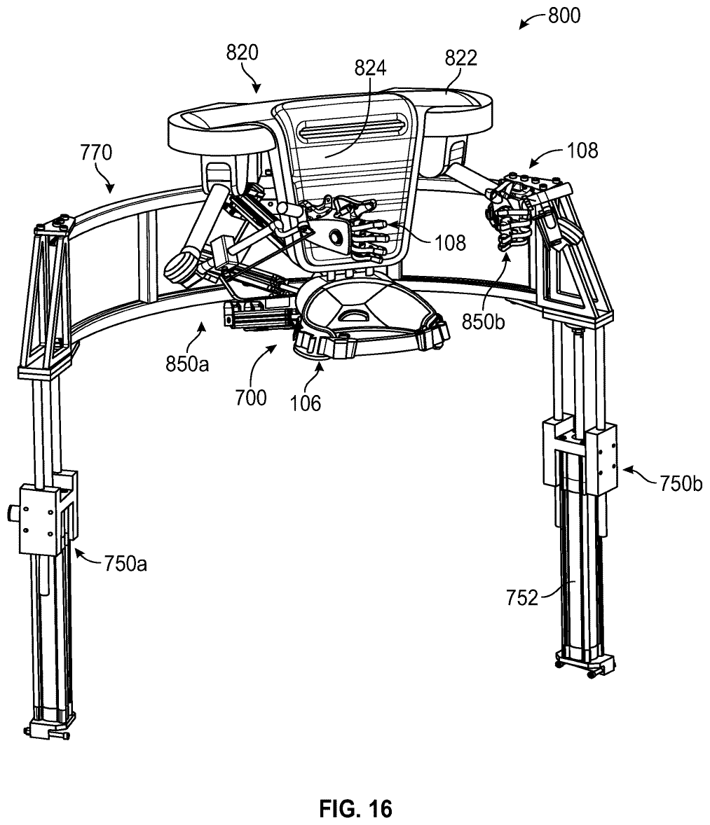

FIG. 16 shows a core assembly of FIG. 9 in accordance with an example embodiment. The core assembly may include the torso exoskeleton 700 and the upper-body exoskeleton 800 that may include the first manipulator 850a and the second manipulator 850b. The core assembly may also include the upper structural frame 770. As described in the disclosure, the core assembly may also include interface garments 106, 108 (e.g., haptic glove 108), the pneumatic cylinder(s) 752 (e.g., two pneumatic cylinders), and the back support assembly 820 (having the structural frame 822 and the padded backrest 824). These components may provide various degrees of freedom (e.g., actuated degree of freedom 750) for the core assembly such as a first coupled degree of freedom 750a and a second coupled degree of freedom 750b may together provide the actuated degree of freedom 750 for the torso exoskeleton 700. As described in the disclosure, this actuated degree of freedom 750 may be configured to permit translation along the longitudinal axis of the user's body.

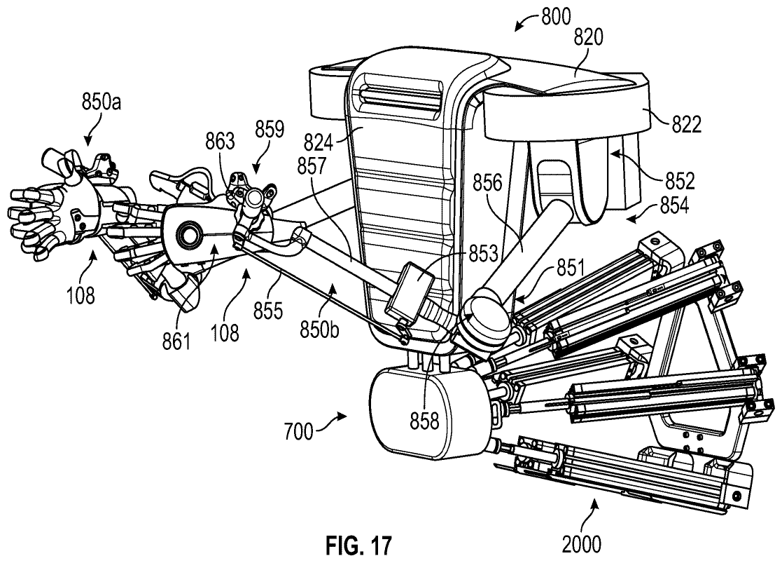

FIG. 17 shows an interface portion of the core assembly of FIG. 16 in accordance with an example embodiment. This interface portion is similar to the example embodiment of FIG. 8A. The interface portion may include the haptic glove 108 and the upper-body exoskeleton 800. The upper-body exoskeleton 800 may include the back support assembly 820, the structural frame 822, the padded backrest 824, and the manipulators (e.g., the first manipulator 850a and the second manipulator 850b). The upper-body exoskeleton 800 may also include the actuator assembly 853, the drive rod 855, the structural members 856, 857, and the mounting bracket 863. These components of the interface portion including the components of the upper-body exoskeleton 800 together provide for the various actuated degrees of freedom as shown in FIG. 17 and described in the disclosure. For example, the actuated degrees of freedom may include the first actuated degree of freedom 852, the second actuated degree of freedom 854, the third actuated degree of freedom 858, the fourth actuated degree of freedom 851, the fifth actuated degree of freedom 861, and the sixth actuated degree of freedom 859. In this example embodiment, there may also be a torso actuator assembly 2000 attached below the upper-body exoskeleton 800 (e.g., attached to the padded backrest 824 via its own torso backrest). As shown in FIG. 17, the torso actuator assembly 2000 may include several actuators providing one or more degrees of freedom towards moving the user's torso. In this example embodiment, the torso actuator assembly 2000 may be the Stewart type of actuator assembly (e.g., six actuators) that may provide degrees of freedom such as six degrees of freedom. In example embodiments, the components in FIG. 17 may function together to provide the various actuated degrees of freedom 852, 854, 858, 851, 861, 859 similar to the components in FIG. 8A as shown in FIG. 17 and described in the disclosure. Each of these degrees of freedom may be achieved and provided in FIG. 17 using the same or similar approaches described in the disclosure with respect to FIG. 8A.

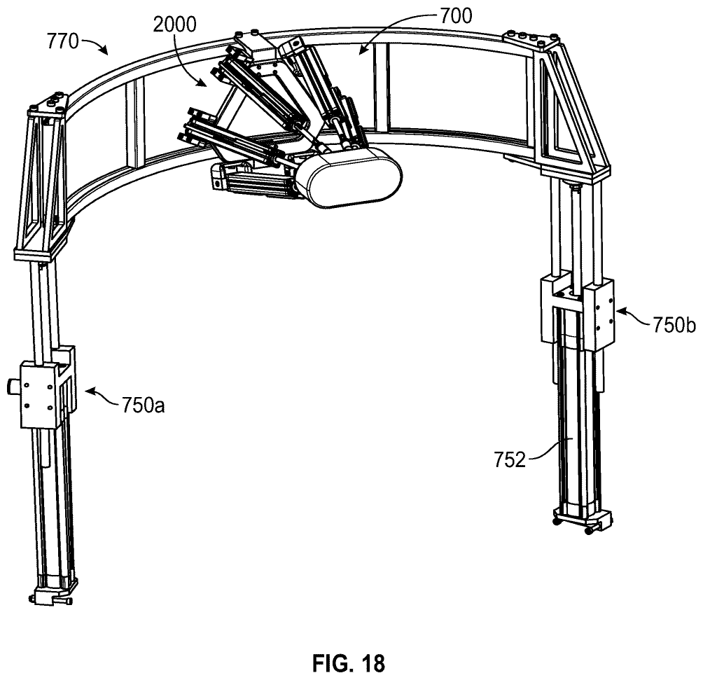

FIG. 18 shows a torso portion of the core assembly of FIG. 16 in accordance with an example embodiment. As shown in previous figures and described in the disclosure, the torso portion includes the torso exoskeleton 700, the pneumatic cylinders 752 (e.g., two pneumatic cylinders), the upper structural frame 770, the upper-body exoskeleton 800, and the torso actuator assembly 2000 (e.g., including several actuators such as six actuators for a Stewart type of actuator assembly). As shown in FIG. 18 and described in the disclosure, the torso exoskeleton 700 may include the actuated degrees of freedom 750 having the first coupled degree of freedom 750a and the second coupled degree of freedom 750b that may be provided at least partially by the use of the pneumatic cylinders. In example embodiments, these coupled degrees of freedom 750a, 750b may provide increased force output and rigidity for the actuated degree of freedom 750.

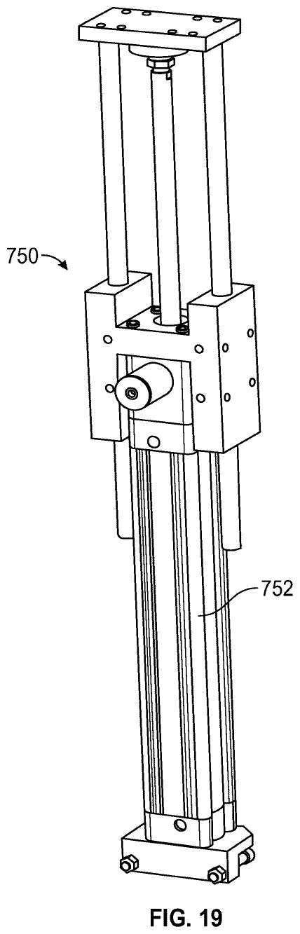

FIG. 19 shows a pneumatic actuator such as the pneumatic cylinder 752 of the core assembly of FIGS. 16 and 18. In example embodiments, the pneumatic actuator (e.g., pneumatic cylinder 752) may be a guided linear servo-pneumatic actuator for providing movement along the core Z-axis. Each pneumatic cylinder 752 may provide for the each coupled degree of freedom 750a relating to the actuated degree of freedom 750 for the torso exoskeleton 700.

### Process Examples for Haptic Device Implementations

In example embodiments, there may be a motion platform toward the bottom of the whole-body haptic device 100 such that its base 302 may be secured to the ground while the motion platform may operate to rotate a portion of the whole-body haptic device 100. By way of these examples and with reference to FIGS. 1, 3, 9 and 10, the motion platform may operate to rotate a portion of the whole-body haptic device 100 to provide a single degree of freedom. By way of these examples, the single degree of freedom may be the bottom rotation such that the user 102 of the whole-body haptic device 100 may experience a yawing movement. (or a spinning, rotational, etc. movement) about an axis that may be generally orthogonal to the ground on which the base 302 of the whole-body haptic device 100 may be secured. For example, rotation of the user 102 and vast majority of the components of the whole-body haptic device 100 may rotate (yaw, spin, etc.) in the same reference plan or reference frame.

In example embodiments, the whole-body haptic device 100 may be configured such that the motion platform may operate to define actual degrees of freedom generally aligned for rotation around the longitudinal axis to the body. In these examples, the whole-body haptic device 100 may be configured such that the motion platform may generally align the longitudinal axis of the body of the user 102 with an axis that may be generally orthogonal to the ground on which the base 302 of the whole-body haptic device 100 may be secured. In further examples, the lower-body exoskeleton 400 may rotate around a central bearing and slip ring assembly (including, for example, the crossed roller bearing 614 in FIG. 6A) that may route electrical power and signal through the rotating junction of the setup.

In example embodiments, the whole-body haptic device 100 may be configured so that such rotation about the motion platform may provide the whole-body haptic device 100 with its sixth degree of freedom or in some configurations, rotation about the motion platform may provide the seventh degree of freedom. In example embodiments, the motion platform may have six degrees of freedom and those degrees of freedom may align with the actuator axes as shown in FIG. 3, such that each of the six actuator axes provides a degree of freedom and adding rotation (or yawing, spinning, etc.) about the user may then be a seventh degree of freedom.

In example embodiments, the motion platform 300 of the whole-body haptic device 100, as depicted in FIGS. 1, 9 and 10, may be configured and later adjusted to provide three degrees of freedom but as described in the disclosure, further functionality may additionally provide four, six or seven degrees of freedom. As described in the disclosure, multiple degrees of freedom may be experienced by each limb of the user, and independently by the torso of the user. It may be appreciated in light of the disclosure that there may be challenges moving such large amounts of mass while still providing the agility and response time required to seamlessly coordinate each of the degrees of freedom. In doing so, there may be significant mass (e.g., hundreds of kilos of mass) spread across the structures of the whole-body haptic device 100. With this reality in mind, the configuration of the motion platform 300 may incorporate a specific mass distribution to increase the agility of the whole-body haptic device 100. By way of these examples, the rigidity may increase the responsiveness of the movement because of the reduced flexibility (e.g., increased rigidity) may make movements crisper when the frame flexes less through the movement. Further specifics with respect to allocating mass throughout the structure of the motion platform 300 to increase its agility and to increase safety by reducing the power needed to move that mass are further described in the disclosure. In example embodiments, by proper arrangement of the degrees of freedom in a kinematic chain, it may result in a lowering of the mass being distributed across the structures of the whole-body haptic device 100.

As shown in FIG. 10, in example embodiments, there may be motion platform motors 1000 to facilitate rotation of the platform but not all of the motion platform motors 1000 need to contain a motor. By way of these examples, some of the assemblies can contain passive guide wheels 1010 and then one or more motion platform motors 1000 can contain a side motor 1020 with a friction wheel 1030, as shown in FIG. 11. Returning to FIG. 10, a central motor 1050 may also be used in lieu of one or more side motors 1020 (FIG. 11) to also facilitate central rotation. In example embodiments, there may be a powered rotational degree of freedom about the axis either facilitated by one or more of the side motors 1020 or the central motor 1050. In the various arrangements, the motion platform can include a central slip assembly 1060 through electrical and data connections can pass while the connections continue to rotate.

In example embodiments, as shown in FIG. 1 and described in the disclosure, there may be a six degree of freedom motion platform 300. For example, one of the degrees of freedom being the rotational (e.g., rotation about the longitudinal axis of the user's body). In example embodiments, the one degree of rotation around the longitudinal axis of the user's body may rotate the whole-body haptic device 100. In example embodiments, the whole-body haptic device 100 may be on a three degree of freedom, a four degree of freedom, a six degree of freedom, or a seven degree of freedom motion platform 300 such that three, four, six, or seven degrees of freedom may be configured. For example, in the four and seven degrees of freedom implementations, the whole-body haptic device 100 may include a rotary actuator motor 900 or a motion platform motor 1000 that may be positioned in the middle of the six degree of freedom motion platform 300 (e.g., Stewart platform) or in the middle of the three degree of freedom Stewart motion platform 300. For example, the rotary actuator motor 900 or the motion platform motor 1000 may spin causing the rotation of the platform. This rotary actuator motor 900 or the motion platform motor 1000 may be positioned under the gantries (e.g., gantries 500, 500a, 500b) of the motion platform 300. For example, the entire upper assembly may rotate around the long axis of platform. The motor (e.g., the rotary actuator motor 900 or the motion platform motor 1000) may need to have sufficient power to accommodate the moving mass. For example, the motion platform 300 may be designed to move significant masses (e.g., about hundreds or thousands of kilos) at relatively high accelerations such that the motor (e.g., rotary actuator motor 900 or motion platform motor 1000) may be configured to accommodate this type of movement of mass.

In example embodiments, the whole-body haptic device 100 may be configured to provide six independent degrees of freedom which may be deployed at and bound by the movement of each of the feet and each of the hands of the user 102, as disclosed herein. By way of these examples, the combination of the six degrees of freedom of the motion platform 300 may functionally be associated with each of the footplates 600a, 600b. It will be appreciated in light of the disclosure that the six degrees of freedom provided to each foot of the user 102 may, in example embodiments, induce the feeling to the user 102 that they are climbing a set of stairs. In doing so, the footplates 600a, 600b may be titled to induce the feeling of incline. In addition or in the alternative, the footplates 600a, 600b may independently but cooperatively adjust an angle of the foot plates 600a, 600b to simulate a motion up and down a rise and run of traditional stairs rather than only increasing ramp angle. It may be appreciated in light of the disclosure that the number of degrees of freedom may be deployed by combinations with other components of the whole-body haptic device 100. By way of these examples, the whole-body haptic device 100 of FIG. 12 depicts, in example embodiments, six degrees of freedom provided at each of the footplate assemblies (e.g., footplates 600a, 600b) but also depicts further degree of freedom in that the portions of the lower-body exoskeleton 400 may rotate by way of the motion platform motors 1000 or the rotary actuator motor 900. As such, components of the whole-body haptic device 100 may cooperatively provide multiple degrees of freedom in the recreation of accurate motion. As such, these example embodiments may vary in design in terms of how these degrees of freedom may be combined and mixed together (e.g., example embodiments may distribute degrees of freedom in various ways).

In example embodiments, the lower body exoskeleton with its two actuated foot platforms 650a, 650b may be configured for substantially supporting a user's weight during the user's ambulation. In some example embodiments, each of the actuated foot platforms 650a, 650b in FIG. 1 may have five degrees of freedom that may share another (e.g., incorporate an additional) six degrees of freedom provided by further components of the whole-body haptic device 100 depicted in FIG. 1. In further example embodiments, each of the actuated foot platforms 650a, 650b in FIG. 9 may have seven degrees of freedom with six from each of the foot platforms 650a, 650b and a further degree of freedom provided by the rotary actuator motor 900 or the motion platform motor 1000. It will be appreciated in light of the disclosure that the configuration of the whole-body haptic device 100, which is depicted in FIGS. 9 and 12, may further minimize the effects of moving mass as much as possible relative to the configuration of the whole-body haptic device 100 depicted in FIGS. 1 and 4. By way of these examples, the whole-body haptic device 100 may be configured with a stack up of all the different degrees of freedom or in some examples, a single global rotation may provide the degree of freedom that was otherwise provided by the stack up or put another way, the coordinated movement across multiple degrees of freedom may simulate the single simulated degree of freedom. In example embodiments, the whole-body haptic device 100 may move all of its system mass and, in addition, the mass of the user 102. In one example embodiment, the whole-body haptic device 100, which is depicted in FIGS. 9 and 12, may be shown to represent a reduction of about 250 kilos relative to the configuration of the whole-body haptic device 100 depicted in FIGS. 1 and 4

In example embodiments where the reduction of mass may be sought, each foot of the user 102 may connect to something else besides two degrees-of-freedom gantries (e.g., gantries 500, 500a, 500b). By way of these examples, XY gantries may be deployed, e.g., a serial or parallel gantry (e.g., gantry 500, 500a, 500b), that may require relatively limited mass but may supply sufficient degrees of freedom alone or in combination with other systems. In several example embodiments, there may be a single degree of freedom such that each of the footplates 600a, 600b may have six degrees of freedom in the form of a pneumatic Stewart platform (as shown in FIG. 9) for each foot platform 650a, 650b. In example embodiments, each platform (e.g., foot platform 650a, 650b) may further ride on a set pair of vertical rails such as pneumatic cylinder 752 that move in and out, as shown generally at the coupled degrees of freedom 750a, 750b together providing the actuated degree of freedom 750. This may provide a redundant seventh degree of freedom hybrid manipulator for both of the actuated foot platforms 650a, 650b. For example, if a sixth-degree-of-freedom parallel system may be used, then there may be an additional seventh-degree-of-freedom that may move in the primary axis of motion, along the frontal axis of the user. This may be shown to provide additional improvements over other example embodiments in addressing relatively high forces, relatively low moving mass, relatively high speeds, and relatively high precision. In some examples, a non-redundant system may be altered to accommodate the full range of motion to users' legs to obtain six-degrees-of-freedom. By way of these examples, the seventh-degree-of-freedom may be added to provide improvements to the user's range of motion (e.g., side stepping, angular deviation such as stepping up on a rock, etc.). In example embodiments, the six-degrees-of-freedom may be provided by the Stewart type of platform with the redundant degrees along the frontal axis of the user in the direction the user may be moving (e.g., walking).

In the various example embodiments, the whole-body haptic device 100 may include the lower-body exoskeleton 400, actuated foot platforms (e.g., two actuated foot platforms 650a, 650b), and key degrees of freedom of the platforms that are described herein. There may be several differences between some of the example embodiments as depicted in FIGS. 1 and 9. By way of these examples, the degrees-of-freedom may be arranged differently in the two depicted versions. In some example embodiments, there may be five degrees of freedom per actuated foot platform 650a, 650b and in other example embodiments there may be six-degrees-of-freedom with the footplates 600 (e.g., footplates 600a, 600b). There may be other examples providing degrees-of-freedom such that most example embodiments may present a six-degree-of-freedom controllable platform for each foot and that may be implemented in different ways. With some example embodiments, there may be implementations with the two exterior platforms and the seventh redundant linear degree of freedom, as depicted in FIG. 9, which may be different than other example embodiments such as what is depicted in FIG. 1. In example embodiments, the lower body exoskeleton 400 may include the footplates 600 such as footplates 600a, 600b (e.g., including the foot platforms 650 such as 650a, 650b) for each foot that may include one or more torque sensors. The footplates 600a, 600b may control their position and orientation space using their gantry component in combination with the footplate component such as the foot platforms 650a, 650b.

In example embodiments, there may be similar modules such that the degree of freedom assemblies may include a six-degree-of-freedom motion platform 300 supplied by pneumatics (e.g., a Stewart type of platform) and a linear pneumatic actuator (e.g., two Stewart actuation systems for each foot and one Stewart actuation system for the torso as shown in FIG. 9). Such a configuration may be shown to provide a virtual motion platform between all of these degrees of freedom. For example, in a vehicle configuration, the z-axis may be lowered when the user may be in a sitting position. By way of these examples, pedaling may be simulated with the foot platforms 650a, 650b of the footplates 600a, 600b. In example embodiments, acceleration queuing may occur for vehicle simulations such that the whole-body haptic device 100 may utilize acceleration simulation by substituting the gravity vector with some degree of tilt for the forward acceleration to use the experienced g-force to provide the needed feel. In example embodiments, there may be a set of ways to essentially trick the vestibular system by combining either tilts or tilts in a relatively small amount of forward acceleration or upper acceleration with washout to create that relative motion. These types of motions may be similar to what may be found in aerospace simulators to induce the feelings (sometimes incorrect feelings) of changing airplane attitude or altitude in the sky. For example, these degrees of freedom may be ranged (or constrained) such as to provide all the same capabilities of that motion platform but no longer have to move around the whole mass (in some examples over 350 kilos) in real time. There may be moving mass at the end effector to minimize the mass of the footplates, the back plate, and the relatively limited moving mass of the actuators. By way of these examples, such an arrangement may eliminate safety concerns that may be necessitated by some of the more complex parts of other example embodiments such as the magnetic floor coupling, which may not be required in other example embodiments. In example embodiments, this may provide at least one linear redundant degree of freedom as described in the disclosure.

In the various example embodiments, there may be the motion platform 300, the lower and upper body exoskeletons 400, 800, and at least two platforms (e.g., foot platforms 650) configured to substantially support each of the user's feet and their total body weight. By way of these examples, the upper body exoskeleton 800 with two manipulators 850a, 850b may provide at least three actuated degrees of freedom. Example embodiments may be implemented in different ways such that some example embodiments may be relatively more decoupled and decrease the mass that may be moved. In some example embodiments, the motion platform 300 may have one degree of freedom instead of seven degrees of freedom. There also may be footplates 600a, 600b which may each provide seven degrees of freedom that may be implemented in a hybrid design. In example embodiments, there may be six degrees of freedom provided in parallel rather than the five degrees of freedom in a serial hybrid rear design. Across example embodiments, there may be relatively similar motions. For example, same or similar force torque sensors may be provided along with similar controls. By way of these examples, a similar Z-axis may be implemented pneumatically providing a hybrid pneumatic, electro-mechanical approach. In example embodiments, a full six degrees of freedom may be provided in these examples.

In example embodiments, reducing the number of degrees of freedom may be a goal in some designs. In some example embodiments, extra motion platform degrees of freedom may be used. To that end, there may be additional mechanisms on top of the motion platform (e.g., motion platform 300) when extra motion may be preferred or needed. For example, the rotary electrical coupling may be configured to permit extra degrees of freedom such as the ability for continuous rotation to at least at about 720 degrees. In some examples, the orientation of the center of mass of the user may be adjusted. In some example embodiments, there may be mapping of the motion platform 300 to the average angle of a ground plane and then the footplates 600a, 600b may be used to map some plates to deviations. For example, if a user is walking up the slope, the system may match the motion platform 300 to the overall slope and the footplates 600a, 600b (including foot platforms 650a, 650b) that may be configured to provide (that is simulate) the small differences of rough terrain or stairs.

In example embodiments, the lower body exoskeleton 800 may have similar or the same degrees of freedom. In example embodiments, a belt driven actuator (e.g., wheel robot such as a robot belt drive actuator) may be used and/or a pneumatic actuator may be used for the drive system. In another example, a cable driven actuator may be used for the drive system.

In example embodiments, the motion platform 300 may have seven degrees of freedom. The motion platform 300 may move to any position or orientation (e.g., within about a few hundred millimeters displacement at about 30 to about 40 degrees such as 35 degrees). In example embodiments, the motion platform 300 including the user 102 may be rotated. This may provide the seventh degree of freedom as combined degrees of freedom. For example, in example embodiments, the whole-body haptic device 100 may rotate or spin around. In example embodiments, there may be six additional degrees of freedom that move the whole-body haptic device 100, including forward, backward, any other orientation, etc. Together this may result in seven degrees of freedom. For example, the Stewart type of motion platform 300 at the base may provide six degrees of freedom in a relatively small area then a full rotation of that frame on top to result in seven degrees of freedom. Thus, it may be considered six degrees of freedom plus one degree of freedom as there may be some redundancy. The Stewart platform may rotate about 30 to about 40 degrees which may provide the six degrees of freedom. The seventh degree of freedom may be provided by the motor that provides the rotation as described in the disclosure such as the motion platform motor 1000 (e.g., motion platform yaw motor) or the rotary actuator motor 900. In some example embodiments, this motor may spin around the components on top of the Stewart platform. Thus, the entire system (e.g., whole-body haptic device 100) may rotate in addition to the six degrees of freedom being provided. In these example embodiments, the goal may be to provide each foot with six degrees of freedom independently at least, and then the center of gravity of the user (e.g., user's waist) may also provide six degrees of freedom independently of each foot. In these example embodiments, these degrees of freedom may be all combined and mixed together. In other example embodiments (e.g., as shown in FIGS. 9-19), there may be less combinations between the degrees of freedom at each foot and at the center of gravity. Thus, in example embodiments, there may be six plus one degrees of freedom for the entire system (e.g., whole-body haptic device 100) plus several degrees of freedom for the feet and the center of gravity. For example, the degrees of freedom may relate to the feet and may relate to moving of the center of gravity around.

As described in the disclosure, FIGS. 1, 4, and 6A show an example embodiment. For example, FIG. 4 shows the that footplates 600a, 600b may be moved by assembly to provide three degrees of freedom. In other example embodiments, as shown in FIG. 9, this may occur in parallel with a two degree of freedom parallel mechanism. This may provide tilting in any orientation. In some example embodiments, there may be motion relating to tilt, side to side tilt, and/or front to back movements. Then, the rotation of each footplate 600 around may result from the bottom rotation (e.g., by motion platform motor 1000 or the rotary actuator motor 900) as described in the disclosure. Thus, combined together the footplate 600 on its own may have zero linear degrees of freedom but has all three of the rotational degrees of freedom. In example embodiments, the footplate 600 may be oriented any which way and/or rotated around. The linear degrees of freedom in this example implementation may be provided by the gantry 500 (e.g., as shown in FIG. 4). In some example embodiments (e.g., as shown in FIG. 9), the gantry 500 may provide one degree of freedom per foot. In other example embodiments (e.g., as shown in FIG. 4), the gantry may have two degrees of freedom per foot. These may be linear Cartesian degrees of freedom such that each footplate 600 may be moved by these gantries 500 forward, backward, left, right, etc. as described in the disclosure. Each foot may move forward, backward, left, or right such that there may be three rotational degrees of freedom. This may provide five degrees of freedom per foot. The degree of freedom that may not be present in some assemblies may be the Z-X axes (e.g., feet up and down).

In example embodiments, these movements may be based on a combination of the motion platform moving and the footplates moving. In example embodiments (e.g., as shown in FIG. 9), simulating stairs may occur by moving one footplate 600a forward and up and moving the other footplate 600b backwards and down. In other example embodiments (e.g., as shown in FIG. 1), the motion platform 300 may be angled down, which may then drop the back foot down and may pull the front foot up. Then, a counter angle of the footplates 600a, 600b may occur such that the motion platform 300 may be moved up and down as needed. Thus, a combination of the planted foot, the angling, and the counter angling may allow for the plant foot to stay in place while everything else moves. The entire system may be moving around the user's body and the front may provide counter angling such that when the user steps up, they may be able to move up from the user's perspective. The footplates 600 may be able to move up and down by leveraging these combined degrees of freedom. The seven degrees of freedom in the motion platform 300 plus the five degrees of freedom per foot may all add up to six degrees of freedom per foot.

With these example embodiments, the motion of the base may affect the center of gravity. These degrees of freedom may be conflated in some example embodiments (e.g., as shown in FIG. 1). In other example embodiments (e.g., as shown in FIG. 9), the degrees of freedom may be separated more distinctly. In example embodiments, some of these degrees of freedom may essentially compensate for the fact that the motion platform 300 may be moving everything and the degrees of freedom may be moving relative to the motion platform 300. For example, when taking a step onto a stair, the entire system may have to reorient itself to keep up with the user 102. In example embodiments, each foot platform 650 may bend forward or backward or side to side when in use which may be similar to movement of bike pedals. This may occur from the user's body being locomotive and from the influence of gravity (e.g., the user may be falling forward with the user being fixed at the waist). In example embodiments, there may be a plane that intersects the center of rotation of each foot that may be no greater in angle than the motion platform.

As described in the disclosure, FIGS. 7A-7B, 8A-8B, and 9 show example embodiments. In example embodiments, there may be a motion providing movement along the longitudinal axis of a user's body (e.g., a combined electromechanical and pneumatic actuation may be used to provide this motion). In other example embodiments, a pneumatic system only may be used such as a single pneumatic cylinder server. With this longitudinal axis motion, there may be movement raising the entire torso up and down. For example, there may be two degrees of freedom that may angle the back plate (e.g., back support assembly 820 in FIG. 8A). This may provide angular motion around the frontal and sagittal axes. The two degrees of freedom may be provided and then each of the arms of the haptic glove 108 may provide six degrees of freedom (e.g., force feedback to the user's arms). FIG. 8A shows an upper-body exoskeleton 800 that may include two arms that may connect the haptic glove 108 and the back support assembly to a pneumatic controller such as the fluidic drive system 826 (e.g., as shown in FIG. 8B). The upper-body exoskeleton 800 may provide a minimum viable fully immersive motion and force feedback experience. There may be six degrees of freedom provided per arm. For example, the user may virtually ride a motorcycle or a horse. For example, the vehicle simulation may be provided with the motion platform. In example embodiments, this implementation may use a configured robotic type of arm that may provide two degrees of freedom in the shoulder assembly. There may be one degree of freedom in the elbow and there may be three degrees of freedom in the wrist. In other example embodiments, the kinematics may be designed to provide three full degrees of freedom with respect to one elbow, two elbows, and one wrist. Even so, with this example embodiment, six degrees of freedom for the back arm may still be provided. There may be different ways to provide these degrees of freedom, but the specific degree combinations may be generally the same or similar. In most example embodiments, the whole-body haptic device 100 may provide a full six degrees of freedom, independent control for both feet, both arms, and the torso providing the ability reproduce most (if not all) human motions or human activities.

In example embodiments, there may be a tracker on the foot to identify where each foot may be located. Each footplate 600 may be used to project the position of that tracker onto a virtual ground where the footplate 600 may be located. Thus, each footplate 600 may not be following each foot but each footplate 600 may be following a shadow that each foot projects onto the ground surface. This may be an angle that may be essentially a two-dimensional or a two and a half dimensional representation of the shadow.

In example embodiments (e.g., as shown in FIGS. 1, 9 and 13), extra redundant degrees of freedom may be provided in the Stewart type of motion platform to provide improved mobility. For example, nine degrees of freedom may be provided for example embodiments. For example, this may utilize a hybrid system providing extra mobility. In other example embodiments, there may be three-linear degrees of freedom and three rotational degrees of freedom. In other example embodiments, there may be two coupled three degree of freedom platforms. In example embodiments, as shown in FIG. 13, there may be an intermediate hybrid type design that instead of having one six degree of freedom Stewart motion platform, there may be two three degrees of freedom Stewart platforms in parallel, both of which Stewart platforms are in series with one rotational degree of freedom. This example embodiment may provide some flexibility in relation to and between the ball and heel of a user's foot which do have some semi-separate movement with respect to each other and the entire foot.

The example embodiments of FIGS. 1-8B may be compared to the example embodiments of FIGS. 9-19 in terms of degrees of freedom. For example, the motion platform of FIGS. 1-8B may provide six plus one degrees of freedom that may include redundant rotation around a longitudinal axis of a user's body whereas the motion platform of FIGS. 9-19 may provide one degree of freedom that may include rotation around the longitudinal axis of a user's body. For the lower body exoskeleton, FIGS. 1-8B may provide five degrees of freedom per foot including no independent motion along the user's longitudinal axis, whereas FIGS. 9-19 may provide six plus one degrees of freedom per foot including redundant movement along the user's frontal axis. For the actuated motion at the user's torso (e.g., related to the upper body exoskeleton), FIGS. 1-8B may provide two degrees of freedom whereas FIGS. 9-19 may provide six plus one degrees of freedom including redundant movement along the user's longitudinal axis. In example embodiments, FIGS. 1-8B include the motion platform 300 that may match a ground plane and actuated motion at the user's torso may accommodate motion required by a gravity vector, and the lower body exoskeleton may accommodate deviations required by topology (e.g., stairs or pedaling simulation). In example embodiments, FIGS. 9-19 may provide independent control of movement of the user's torso and each of user's feet in six plus one degrees of freedom each. While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (Saas), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure. All documents referenced herein are hereby incorporated by reference as if fully set forth herein.

1. A haptic device comprising:
a motion platform including:
an actuated degree of freedom configured to permit rotation about a longitudinal axis of a user's body;
a lower-body exoskeleton, comprising:
two actuated platforms, each platform configured to substantially support a user's weight during ambulation;
an upper-body exoskeleton, comprising:
two manipulators, each manipulator including at least three actuated degrees of freedom; and
an interface garment, including:
a first haptic glove coupled to a first manipulator of the two manipulators, and
a second haptic glove coupled to a second manipulator of the two manipulators.

2. The haptic device of claim 1, wherein the motion platform further comprises:
a first actuated degree of freedom configured to permit rotation about a sagittal axis of the user's body, and
a second actuated degree of freedom configured to permit rotation about a frontal axis of the user's body.

3. The haptic device of claim 2, wherein the motion platform further comprises:
a first actuated degree of freedom configured to permit translation along the sagittal axis of the user's body,
a second actuated degree of freedom configured to permit translation along the frontal axis of the user's body, and
a third actuated degree of freedom configured to permit translation along the longitudinal axis of the user's body.

4. The haptic device of claim 1, wherein the motion platform further comprises a rotary electrical coupling configured to permit the actuated degree of freedom to continuously rotate at least about 720 degrees.

5. The haptic device of claim 1, wherein the actuated degree of freedom of the motion platform is configured to rotate such that it substantially matches an orientation of a center of mass of a user.

6. The haptic device of claim 2, wherein the sagittal and frontal degrees of freedom of the motion platform are actuated such that an orientation of a top surface of the motion platform substantially matches an orientation of a corresponding section of terrain of a computer-mediated environment.

7. The haptic device of claim 1, wherein the lower-body exoskeleton comprises:
a first actuated degree of freedom configured to permit rotation about the longitudinal axis of the user's foot,
a second actuated degree of freedom configured to permit translation along a sagittal axis of the user's foot, and
a third actuated degree of freedom configured to permit translation along a frontal axis of the user's foot.

8-11. (canceled)

12. The haptic device of claim 1, wherein the lower-body exoskeleton comprises:
a first actuated degree of freedom configured to permit rotation about the longitudinal axis of the user's foot,
a second actuated degree of freedom configured to permit translation along the frontal axis of the user's foot,
a third actuated degree of freedom configured to permit translation along the sagittal axis of the user's foot,
a fourth actuated degree of freedom configured to permit rotation about the sagittal axis of the user's foot, and
a fifth actuated degree of freedom configured to permit rotation about the frontal axis of the user's foot.

13. The haptic device of claim 12, wherein the lower-body exoskeleton comprises:
a sixth actuated degree of freedom configured to permit translation along the longitudinal axis of the user's foot.

14. The haptic device of claim 12, wherein the lower-body exoskeleton comprises:
a redundant actuated degree of freedom configured to permit translation along the frontal axis of the user's foot.

15. (canceled)

16. The haptic device of claim 7, further comprising a multiple-degree-of-freedom motion capture system configured to track a position of a user's foot.

17. The haptic device of claim 7, wherein the platforms of the lower-body exoskeleton are actuated so as to substantially match a position of a foot of a user projected onto a plane defined by a range of motion of the second and third actuated degrees of freedom.

18. The haptic device of claim 1, wherein the platforms of the lower-body exoskeleton further comprise a force sensor.

19. The haptic device of claim 18, wherein the force sensor comprises at least three sensed degrees of freedom.

20. The haptic device of claim 18, wherein the platforms of the lower-body exoskeleton are actuated to produce motion of the platforms proportional to a sensed force vector of the force sensor.

21-43. (canceled)

44. The haptic device of claim 1, further comprising a torso exoskeleton coupled to a torso of a user by use of an element capable of substantially supporting the user's weight.

45-51 (canceled)

52. The haptic device of claim 1, wherein the upper-body exoskeleton comprises:
a first actuated degree of freedom configured to permit rotation about a sagittal axis of the user's body, and
a second actuated degree of freedom configured to permit rotation about a frontal axis of the user's body.

53. The haptic device of claim 52, wherein an orientation of another actuated degree of freedom of the upper-body exoskeleton is configured to substantially match the orientation of a user's upper body.

54-56 (canceled)

57. The haptic device of claim 12, wherein the platform of the lower-body exoskeleton is configured to emulate a foot control of a simulated vehicle.

58. The haptic device of claim 57, wherein the platform of the lower-body exoskeleton is configured to emulate at least one of: a brake pedal or a gas pedal.

59. The haptic device of claim 57, wherein the platform of the lower-body exoskeleton is configured to emulate an aircraft rudder pedal.
